(19) United States
(12) Patent Application Publication
(10) Pub. No.: US 2017/0040819 A1
(43) Pub. Date: Feb. 9, 2017

(54) POWER DELIVERY DEVICE, AC ADAPTER, AC CHARGER, ELECTRONIC APPARATUS AND POWER DELIVERY SYSTEM

(71) Applicant: ROHM CO., LTD., Ukyo-Ku (JP)

(72) Inventor: Akihiro ONO, Ukyo-Ku (JP)

(21) Appl. No.: 15/333,601

(22) Filed: Oct. 25, 2016

Related U.S. Application Data
(63) Continuation of application No. PCT/JP2015/060616, filed on Apr. 3, 2015.

(30) Foreign Application Priority Data
Apr. 25, 2014 (JP) 2014-091700

(51) Int. Cl. H02J 7/00; H02M 3/335

(52) U.S. Cl. CPC H02J 7/0052; H02M 3/33592; H02J 2007/0059

(57) ABSTRACT

The PD device includes: a DC/DC converter disposed between an input and an output; a primary-side controller configured to control an input current of the DC/DC converter; and a signal conversion circuit coupled to a plurality of control inputs, the signal conversion circuit configured to switch a control input signal of the plurality of the control inputs; and a secondary-side controller coupled to the signal conversion circuit, the secondary-side controller configured to receive the control input signal switched in the signal conversion circuit, and then feed back the received control input signal to the primary-side controller. The primary-side controller varies an output voltage value and an available output current capacity (MAX value) of the DC/DC converter by controlling the input current on the basis of the control input signal fed back from the secondary-side controller.

### CROSS REFERENCE TO RELATED APPLICATIONS

This is a continuation application (CA) of PCT Application No. PCT/JP2015/060616, filed on Apr. 3, 2015, which claims priority to Japan Patent Application No. P2014-091700 filed on Apr. 25, 2014 and is based upon and claims the benefit of priority from prior Japanese Patent Applications No. P2014-091700 filed on Apr. 25, 2014 and PCT Application No. PCT/JP2015/060616, filed on Apr. 3, 2015, the entire contents of each of which are incorporated herein by reference.

### FIELD

The embodiments described herein relate a Power Delivery device (PD device), an Alternating Current (AC) adapter, an AC charger, an electronic apparatus, and a Power Delivery system (PD system). In particular, the embodiments relate a PD device, an AC adapter, an AC charger, an electronic apparatus, and a PD system, each which is capable of switching with respect to a plurality of apparatuses, and each which has a variable function of an output voltage value and an available output current capacity (MAX value).

### BACKGROUND

Conventionally, there have been provided Direct Current (DC) outlets which can intercommunicate between terminal devices and power line carrier communication networks supporting telecommunications standards with the PD.

There are Power over Ethernet (PoE) technology and Universal Serial Bus (USB) technology as a Power Delivery technology (PD technology) using data lines.

As the USB technologies, there are USB 2.0 Standard up to maximum supply power of 2.5 W, USB 3.1 Standard up to maximum supply power of 4.5 W, and Battery Charging (BC) Revision 1.2 up to maximum supply power of 7.5 W according to the Power Delivery level (PD level).

Moreover, a USB Power Delivery (USB PD) Specification is compatible with existing cables and existing connectors, and coexists also with the USB 2.0 Standard, the USB 3.1 Standard, and the USB-BC Revision 1.2. In such a specification, values of the charging current and voltage is selectable within a range of voltage 5V-12V-20V and a range of current 1.5 A-2 A-3 A-5 A, and the USB electric charging and power transmission can be achieved to be 10 W, 18 W, 36 W, 65 W, and the maximum of 100 W.

DC/DC converters have been used as a power source for achieving such a Power Delivery (PD). There are a diode rectification system and a synchronous rectification method in the DC/DC converters.

### SUMMARY

The embodiments provide a PD device, an AC adapter, an AC charger, an electronic apparatus, and a PD system, each capable of switching with respect to a plurality of apparatuses, and each capable of controlling an output voltage value and an available output current capacity (MAX value).

According to one aspect of the embodiments, there is provided a power delivery device comprising: a DC/DC converter disposed between an input and an output; a primary-side controller configured to control an input current of the DC/DC converter; a signal conversion circuit coupled to a plurality of control inputs, the signal conversion circuit configured to switch a control input signal of the plurality of the control inputs; and a secondary-side controller coupled to the signal conversion circuit, the secondary-side controller configured to receive the control input signal switched in the signal conversion circuit, and then feed back the received control input signal to the primary-side controller, wherein the primary-side controller varies an output voltage value and an available output current capacity of the DC/DC converter by controlling the input current on the basis of the control input signal fed back from the secondary-side controller.

According to another aspect of the embodiments, there is provided a power delivery device comprising: a DC/DC converter disposed between an input and an output; a primary-side controller configured to control an input current of the DC/DC converter; a signal conversion circuit coupled to a plurality of control inputs, the signal conversion circuit configured to switch a control input signal of the plurality of the control inputs; and an insulation circuit coupled to the signal conversion circuit, the insulation circuit configured to receive the control input signal switched in the signal conversion circuit, and then feed back the received control input signal to the primary-side controller, wherein the primary-side controller varies an output voltage value and an available output current capacity of the DC/DC converter by controlling the input current on the basis of the control input signal fed back from the insulation circuit.

According to still another aspect of the embodiments, there is provided an AC adapter comprising the power delivery device mentioned above.

According to yet another aspect of the embodiments, there is provided an electronic apparatus comprising the power delivery device mentioned above.

According to further aspect of the embodiments, there is provided a power delivery system comprising a power delivery device, the power delivery device comprising: a DC/DC converter disposed between an input and an output; a primary-side controller configured to control an input current of the DC/DC converter; a signal conversion circuit coupled to a plurality of control inputs, the signal conversion circuit configured to switch a control input signal of the plurality of the control inputs; and a secondary-side controller coupled to the signal conversion circuit, the secondary-side controller configured to receive the control input signal switched in the signal conversion circuit, and then feed back the received control input signal to the primary-side controller, wherein the primary-side controller varies an output voltage value and an available output current capacity of the DC/DC converter by controlling the input current on the basis of the control input signal fed back from the secondary-side controller.

According to the embodiments, there can be provided the PD device, the AC adapter, the AC charger, the electronic apparatus, and the PD system, each capable of switching with respect to the plurality of the apparatuses, and each capable of controlling the output voltage value and the available output current capacity (MAX value).

### BRIEF DESCRIPTION OF DRAWINGS

FIG. 1 is a schematic circuit block configuration diagram showing a PD device according to basic technology.

FIG. 2 is a schematic circuit block configuration diagram showing a PD device according to a first embodiment.

FIG. 3A is a schematic diagram showing a relationship of an output voltage and an output current obtained using the PD device according to the first embodiment, which is an example of a rectangular shape showing a Constant Voltage Constant Current (CVCC).

FIG. 3B is a schematic diagram showing the relationship of the output voltage and the output current obtained using the PD device according to the first embodiment, which is an example of a fold-back shape of an inverted trapezium.

FIG. 3C is a schematic diagram showing the relationship of the output voltage and the output current obtained using the PD device according to the first embodiment, which is an example of a fold-back shape of an inverted triangle.

FIG. 3D is a schematic diagram showing the relationship of the output voltage and the output current obtained using the PD device according to the first embodiment, which is an example of a trapezoidal shape.

FIG. 3E is a schematic diagram showing the relationship of the output voltage and the output current obtained using the PD device according to the first embodiment, which is an example of a pentagon shape.

FIG. 4A is a schematic circuit block configuration diagram showing a secondary-side controller applied to the PD device according to the first embodiment.

FIG. 4B is another schematic circuit block configuration diagram showing the secondary-side controller applied to the PD device according to the first embodiment.

FIG. 5 is a schematic circuit block configuration diagram showing a PD device according to a modified example 1 of the first embodiment.

FIG. 6 is a schematic circuit block configuration diagram showing a PD device according to a modified example 2 of the first embodiment.

FIG. 7 is a schematic circuit block configuration diagram showing a PD device according to a modified example 3 of the first embodiment.

FIG. 8 is a schematic circuit block configuration diagram showing a PD device according to a modified example 4 of the first embodiment.

FIG. 9 is a schematic circuit block configuration diagram showing a PD device according to a second embodiment.

FIG. 10 is a schematic circuit block configuration diagram showing a PD device according to a third embodiment.

FIG. 11 is a schematic circuit block configuration diagram showing a PD device according to a fourth embodiment.

FIG. 12 is a schematic circuit block configuration diagram showing a PD device according to a fifth embodiment.

FIG. 13 is a schematic circuit block configuration diagram showing a PD device according to a sixth embodiment.

FIG. 14 is a schematic circuit block configuration diagram showing a PD device according to a seventh embodiment.

FIG. 15A is a schematic circuit block configuration diagram showing a PD device according to an eighth embodiment.

FIG. 15B is a schematic circuit block configuration diagram showing a PD device according to a modified example of the eighth embodiment.

FIG. 16 is a schematic circuit block configuration diagram of a metal oxide semiconductor (MOS) switch applied to the PD device according to the embodiments.

FIG. 17A shows an example of connecting a USB PD and the PD device (PD) according to the embodiments in an AC adapter/AC charger with external plugs, in an example of wire connection for connecting the AC adapter/AC charger with a plug capable of being connected to an outlet using a cable.

FIG. 17B shows another example of connecting a USB PD and the PD device (PD) according to the embodiments in the AC adapter/AC charger with external plugs, in the example of wire connection for connecting the AC adapter/AC charger with the plug capable of being connected to the outlet using the cable.

FIG. 18A shows an example of including the USB PD and the PD device (PD) according to the embodiments in the AC adapter/AC charger, in an example of containing a plug capable of being connected to the outlet in the AC adapter/AC charger.

FIG. 18B shows an example of connecting receptacles contained in the AC adapter/AC charger to the external plugs, in the example of containing the plug capable of being connected to the outlet in the AC adapter/AC charger.

FIG. 19A shows an example of connecting the PD in the AC adapter/AC charger to the external plug, in an example of wire connection for connecting the AC adapter/AC charger to the plug capable of being connected to the outlet using the cable.

FIG. 19B shows an example of including a receptacle in the AC adapter/AC charger, in the example of wire connection for connecting the AC adapter/AC charger to the plug capable of being connected to the outlet using the cable.

FIG. 19C shows an example of connecting a plug contained in the AC adapter/AC charger to the external plug, in the example of wire connection for connecting the AC adapter/AC charger to the plug capable of being connected to the outlet using the cable.

FIG. 20A shows an example of connecting the PD in the AC adapter/AC charger to the external plug, in an example of wire connection for connecting the AC adapter/AC charger to the plug capable of being connected to the outlet using a USB PD cable.

FIG. 20B shows an example of including the receptacle in the AC adapter/AC charger, in the example of wire connection for connecting the AC adapter/AC charger to the plug capable of being connected to the outlet using the USB PD cable.

FIG. 20C shows an example of connecting the plug contained in the AC adapter/AC charger to the external plug, in the example of wire connection for connecting the AC adapter/AC charger to the plug capable of being connected to the outlet using the USB PD cable.

FIG. 21A shows an example of connecting the PD in the AC adapter/AC charger to the external plug, in an example of containing the plug capable of being connected to the outlet in the AC adapter/AC charger.

FIG. 21B shows an example of including the receptacle in the AC adapter/AC charger, in the example of containing the plug capable of being connected to the outlet in the AC adapter/AC charger.

FIG. 21C shows an example of connecting the plug contained in the AC adapter/AC charger to the external plugs, in the example of containing the plug capable of being connected to the outlet in the AC adapter/AC charger.

FIG. 22A shows an example of respectively connecting a plurality of the PDs in the AC adapter/AC charger to a plurality of the external plugs, in an example of containing the plug capable of being connected to the outlet in the AC adapter/AC charger.

FIG. 22B shows an example of including a plurality of the receptacles in the AC adapter/AC charger, in the example of containing the plug capable of being connected to the outlet in the AC adapter/AC charger.

FIG. 22C shows an example of respectively connecting a plurality of the plugs contained in the AC adapter/AC charger to a plurality of the external plugs, in the example of containing the plug capable of being connected to the outlet in the AC adapter/AC charger.

FIG. 23A shows in particular an example of including a plurality of internal circuits containing the USB PD device therein in an electronic apparatus, having a plurality of signals using the USB PD, in an example of wire connection for connecting the electronic apparatus to the plug capable of being connected to the outlet using the cable.

FIG. 23B shows an example of including the plug capable of being connected to the outlet in the electronic apparatus, and the plurality of the internal circuits containing the USB PD device therein are included in the electronic apparatus, having the plurality of the signals using the USB PD device.

FIG. 24A shows in particular an example of including the USB PD connected to the outside in one internal circuit, in an example in which the plug capable of being connected to the outlet is included in the electronic apparatus, and the plurality of the internal circuits containing the USB PD device therein are included in the electronic apparatus, having the plurality of the signals using the USB PD device.

FIG. 24B shows in particular an example of including a plurality of the USB PD devices connected to the outside in one internal circuit, in the example in which the plug capable of being connected to the outlet is included in the electronic apparatus, the plurality of the internal circuits containing the USB PD device therein are included in the electronic apparatus, having the plurality of the signals using the USB PD device.

FIG. 25A is an explanatory diagram of a protection function of the USB PD device according to the embodiments in the case where a smart phone is used as a connecting target.

FIG. 25B is an explanatory diagram of a protection function of the USB PD device according to the embodiments in the case where a laptop Personal Computer (PC) is used as a connecting target.

FIG. 26 shows a schematic bird's-eye view structure example of a PD device, in which a receptacle is mounted, according to the embodiments, applicable to an AC adapter, an AC charger, and an electronic apparatus.

FIG. 27 shows a schematic bird's-eye view structure example of a PD device, in which a receptacle is mounted, according to the embodiments, applicable to the AC adapter, the AC charger, and the electronic apparatus.

FIG. 28 shows a schematic bird's-eye view structure example of a PD device, in which a plurality of receptacles are mounted, according to the embodiments, applicable to the AC adapter, the AC charger, and the electronic apparatus.

FIG. 29 shows a schematic bird's-eye view structure example of a PD device, in which a plug is mounted, according to the embodiments, applicable to the AC adapter, the AC charger, and the electronic apparatus.

FIG. 30 is a schematic circuit block configuration diagram showing the PD device according to the embodiments connected to a plurality of connecting targets through a plurality of the receptacles.

FIG. 31 shows a schematic bird's-eye view structure example of a PD device, in which a plurality of receptacles and a switch are mounted, according to the embodiments, applicable to the AC adapter, the AC charger, and the electronic apparatus.

FIG. 32A is a schematic circuit block configuration diagram for explaining an example of using control input output signals for a USB PD communications between a plurality of the PD devices according to the embodiments.

FIG. 32B is a schematic circuit block configuration diagram showing a case where the control input output signals are passed through an inside of the signal conversion circuit in FIG. 32A.

FIG. 33 is a schematic block configuration diagram for explaining the data communications and the PD between two PCs, in the PD system to which the PD device according to the embodiments can be applied.

FIG. 34A is a schematic block configuration diagram for explaining the data communications and the PD between two units, in the PD system to which the PD device according to the embodiments can be applied.

FIG. 34B is a schematic block configuration diagram showing a PD system including an AC adapter and a smartphone each containing the PD device according to the embodiments.

FIG. 35 is a schematic block configuration diagram of a PD system including two units each containing the PD device according to the embodiments.

FIG. 36 is a schematic block configuration diagram showing a PD system to which the PD device according to the embodiments can be applied, including other two units.

FIG. 37 is a schematic block configuration diagram showing a first PD system to which the PD device according to the embodiments can be applied.

FIG. 38 is a schematic block configuration diagram showing a second PD system to which the PD device according to the embodiments can be applied.

FIG. 39 is a schematic block configuration diagram showing a third PD system to which the PD device according to the embodiments can be applied.

FIG. 40 is a schematic block configuration diagram showing a fourth PD system to which the PD device according to the embodiments can be applied.

FIG. 41 is a schematic block configuration diagram showing a configuration in which a controller and a signal conversion circuit are contained in a CPU interface, in the PD system to which the PD device according to the embodiments can be applied.

### DESCRIPTION OF EMBODIMENTS

Next, certain embodiments will be described with reference to drawings. In the description of the following drawings, the identical or similar reference numeral is attached to the identical or similar part. However, it should be noted that the drawings are schematic and the relation between thickness and the plane size and the ratio of the thickness of each component part differs from an actual thing. Therefore, detailed thickness and size should be determined in consideration of the following explanation.

Of course, the part from which the relation and ratio of a mutual size differ also in mutually drawings is included. Moreover, the embodiments described hereinafter merely exemplify the device and method for materializing the technical idea; and the embodiments do not specify the material, shape, structure, placement, etc. of each component part as the following. The embodiments may be changed without departing from the spirit or scope of claims.

### [Basic Technology]

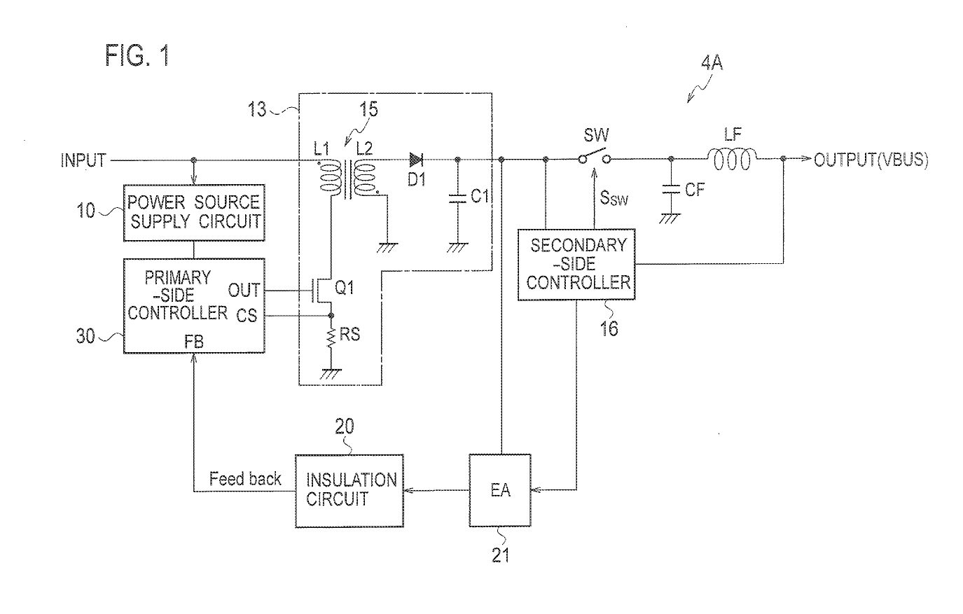

As shown in FIG. 1, a PD device 4A according to a basic technology includes: a DC/DC converter 13 disposed between an input and an output, DC/DC converter 13 including a transformer 15, a diode D1, a capacitor C1, and a MOS transistor Q1 and a resistor RS connected in series between a primary-side inductance L1 of the transformer 15 and a ground potential; a primary-side controller 30 configured to control the MOS transistor Q1; a power source supply circuit 10 connected between the input and the primary-side controller 30, the power source supply circuit 10 configured to supply a power source to the primary-side controller 30; a secondary-side controller 16 connected to the output, the secondary-side controller 16 capable of controlling an output voltage Vo and an output current Io; an error amplifier 21 for error compensation connected to an output of the DC/DC converter 13 and the secondary-side controller 16; and an insulation circuit 20 connected to the error amplifier 21, the insulation circuit 20 configured to feed back output information to the primary-side controller 30.

Moreover, the secondary-side controller 16 may be connected to the output (VBUS) through an AC coupling capacitor CC (not shown in FIG. 1).

Moreover, as shown in FIG. 1, the PD device 4A according to the basic technology includes: a switch SW configured to interrupt the output of the DC/DC converter 13 and the power line output (VBUS); and a filter circuit (LF, CF) disposed between the switch SW and the power line output (VBUS). ON/OFF control for the switch SW can be executed by the secondary-side controller 16.

An AC signal is superimposed to be input into the power line output (VBUS) from the outside, in the PD device 4A according to the basic technology.

In the PD device 4A according to the basic technology, the control input signal is input into the secondary-side controller 16 through the AC coupling capacitor CC from the power line output (VBUS), and electric power information at the output side is fed back to the primary-side controller 30 through the error amplifier 18 and the insulation circuit 20. The primary-side controller 30 controls ON/OFF of the MOS transistor Q1, thereby stabilizing the output voltage.

Moreover, in the PD device 4A according to the basic technology, an amount of current conducted to the primary-side inductance L1 is detected by the current sensing resistor RS, and an amount of current, e.g. a primary-side overcurrent, is controlled in the primary-side controller 30. As a consequence, the PD device 4A according to the basic technology has a variable function of an output voltage value and available output current capacity (MAX value).

In the PD device 4A according to the basic technology, the variable function of the output voltage value and the available output current capacity (MAX value) of the step-down (buck) type DC/DC converter 13 is realized by the feedback control from the secondary-side controller 16 to the primary-side controller 30. Accordingly, a relationship between the output voltage Vo and the output currents Io can be varied (variable function) in accordance with loads (e.g., smart phones, laptop PCs, tablet PCs, etc.) connected to the output.

The inductance LF formed with a filter coil at the output side is a separating inductance. More specifically, the filter circuit including the inductance LF and the capacitor CF separates a control signal from the DC/DC converter in order that the control input signal from the output is not input into the DC/DC converter 13. The inductance LF has relatively large mounting space, and hereby obstructing miniaturization and cost reduction.

### First Embodiment

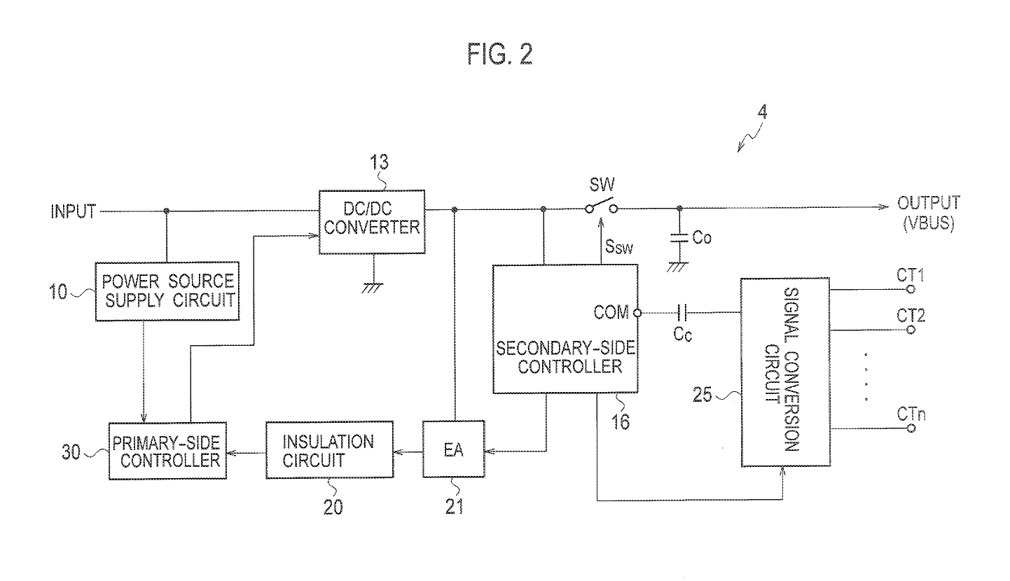

As shown in FIG. 2, a PD device 4 according to a first embodiment includes: a DC/DC converter 13 disposed between an input and an output; a primary-side controller 30 configured to control an input current of the DC/DC converter 13; a signal conversion circuit 25 coupled to a plurality of control inputs, the signal conversion circuit 25 configured to switch a control input signal of a plurality of control inputs; and a secondary-side controller 16 coupled to the signal conversion circuit 25, the secondary-side controller 16 configured to receive the control input signal switched in the signal conversion circuit 25, and then feed back the received control input signal to the primary-side controller 30.

The control input signal switched in the signal conversion circuit 25 is input into a communication terminal COM of the secondary-side controller 16. Moreover, the primary-side controller 30 varies an output voltage value and an available output current capacity (MAX value) of the DC/DC converter 13 by controlling the input current of the DC/DC converter 13 on the basis of the control input signal fed back from the secondary-side controller 16. Moreover, an output capacitor CO is connected between the power line output (VBUS) and a ground potential.

Moreover, as shown in FIG. 2, there may be included a plurality of control terminals CT1, CT2, . . . , CTn, and a plurality of the control inputs may be coupled to the plurality of the controls terminals CT1, CT2, . . . , CTn. Moreover, a control output signal of the PD device 4 according to the first embodiment can be output to an external apparatus through the plurality of the control terminals CT1, CT2, . . . , CTn.

Moreover, the PD device 4 according to the first embodiment may include AC coupling capacitors Ct1, Ct2, . . . , Ctn coupled to the plurality of the control inputs, and the signal conversion circuit 25 may be coupled to the plurality of the control inputs respectively through the AC coupling capacitors Ct1, Ct2, . . . , Ctn.

Moreover, the plurality of the control inputs may be directly connected to the signal conversion circuit 25. More specifically, the control input signals of the plurality of the control inputs may be directly input to the signal conversion circuit 25 without through the AC coupling capacitors Ct1, Ct2, . . . , Ctn.

Moreover, the PD device 4 according to the first embodiment may include a coupling capacitor CC configured to couple the secondary-side controller 16 and the signal conversion circuit 25 to each other. Moreover, between the secondary-side controller 16 and the signal conversion circuit 25 may be directly connected without through the coupling capacitor CC.

In the PD device 4 according to the first embodiment, the signal conversion circuit 25 can execute a frequency conversion, a direct current (DC) level conversion, or an amplitude level conversion, for example.

Moreover, in the PD device 4 according to the first embodiment, the signal conversion circuit 25 may be controlled by the secondary-side controller 16.

Moreover, as shown in FIG. 2, the PD device 4 according to the first embodiment may include the insulation circuit 20 connected to the secondary-side controller 16, the insulation circuit 20 configured to feed back the control input signal to the primary-side controller 30. A capacitor, a photo coupler, a transformer, etc. is applicable to the insulation circuit 20. Moreover, as usage, a bidirectional transformer having an insulated driver, a bilateral device, etc. may also be applied thereto.

Moreover, as shown in FIG. 2, the PD device 4 according to the first embodiment may include the error amplifier 21 for error compensation connected to the secondary-side controller 16, the error amplifier 21 configured to feed back the control input signal to the insulation circuit 20. The error amplifier 21 is controlled by the secondary-side controller 16 and can execute an error compensation of the control input signal to be fed back to the insulation circuit 20.

Moreover, as shown in FIG. 2, the PD device 4 according to the first embodiment may include the switch SW connected to the output of the DC/DC converter 13, the switch SW configured to interrupt an output voltage of the DC/DC converter 13. The output of the DC/DC converter 13 and the power line output (VBUS) can be interrupted by the switch SW. ON/OFF control for the switch SW can be executed by the secondary-side controller 16. The switch SW may include a Metal Oxide Semiconductor Field Effect Transistor (MOSFET).

Moreover, as shown in FIG. 2, the PD device 4 according to the first embodiment may include a power source supply circuit 10 connected between an input of the DC/DC converter 13 and the primary-side controller 30, the power source supply circuit 10 configured to supply electric power to the primary-side controller 30.

In the PD device 4 according to the first embodiment, there are included the plurality of the control inputs in addition to the power line output (VBUS), instead of the basic technology with which the AC signal is superimposed to be input into the power line output (VBUS) from the outside. Accordingly, the separating inductance LF is not necessarily required. More specifically, there is no need to separate the control signal from the DC/DC converter by the filter circuit including the inductance LF and the capacitor CF in order that the control input signal from the output is not input into the DC/DC converter 13. Accordingly, mounting space can be relatively reduced, and therefore miniaturization and cost reduction can be realized, in the PD device 4 according to the first embodiment.

In the PD device 4 according to the first embodiment, the control input signal is input from the plurality of the control inputs through AC coupling capacitors Ct1, Ct2, . . . , Ctn, and the control input signal switched in the signal conversion circuit 25 is further input into the secondary-side controller 16, and then control information including electric power information at the output side is fed back to the primary-side controller 30 through the error amplifier 18 and the insulation circuit 20 in accordance with the control input signal. The primary-side controller 30 controls ON/OFF of the MOS transistor Q1, thereby stabilizing the output voltage.

Moreover, the PD device according to the first embodiment can also use the control input signal input from the plurality of the control inputs through the AC coupling capacitors Ct1, Ct2, . . . , Ctn for USB PD communications, in the same manner as the basic technology.

In the PD device 4 according to the first embodiment, the variable function of the output voltage value and the available output current capacity (MAX value) of the step-down (buck) type DC/DC converter 13 is realized by the feedback control from the secondary-side controller 16 to the primary-side controller 30. Accordingly, a relationship between the output voltage Vo and the output currents Io can be varied (variable function) in accordance with loads (e.g., smart phones, laptop PCs, tablet PCs, etc.) connected to the output.

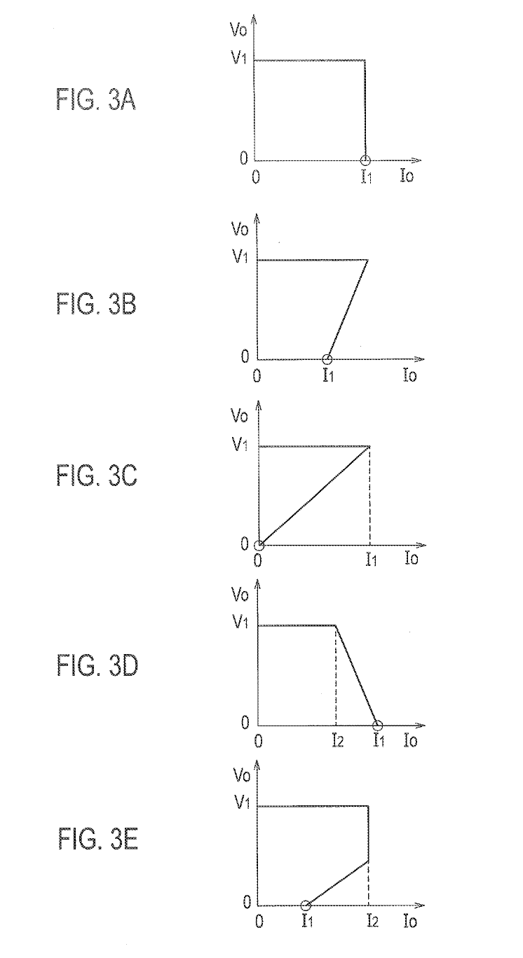

As the relationship between the output voltage Vo and the output current Io obtained by using the PD device 4 according to the first embodiment, there can be adopted various shape, e.g. a rectangular shape as shown in FIG. 3A, a fold-back shape of inverted trapezium as shown in FIG. 3B, a fold-back shape of inverted triangle as shown in FIG. 3C, a trapezoidal shape as shown in FIG. 3D, and a pentagonal shape as shown in FIG. 3E. For example, the rectangular shape shown in FIG. 3A is an example of Constant Voltage Constant Current (CVCC).

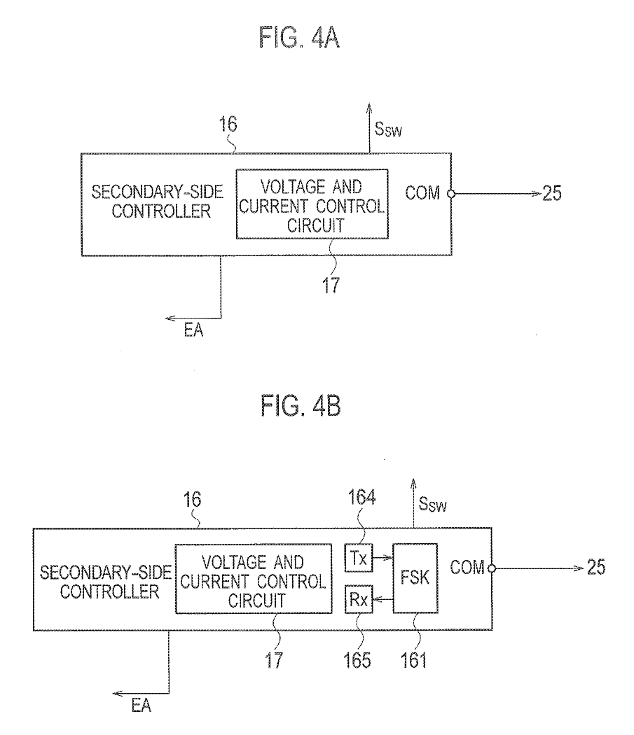

In the PD device according to the first embodiment, as shown in FIG. 4A, the secondary-side controller 16 includes a voltage and current control circuit 17 configured to execute determination of voltage and current on the basis of the control input signal, the voltage and current control circuit 17 configured to control the output voltage Vo and the output current Io. Moreover, the control input signal may include a signal based on a half-duplex communication system. For example, a frequency may be fixed at 150 kHz (300 kbps), and a pulse width of ON/OFF of “1”/“0” may be modulated.

Moreover, as shown in FIG. 4B, the secondary-side controller 16 applied to the PD device according to the first embodiment may further contain a frequency conversion circuit (FSK) 161, a transmitter 164 and receiver 165. In the present embodiment, a frequency conversion from approximately 23.2 MHz to approximately 500 kHz, for example, can be realized by the frequency conversion circuit 161, the transmitter 164, and the receiver 165.

Moreover, in the PD device according to the first embodiment, the signal conversion circuit 25 instead of the secondary-side controller 16 may include the voltage and current control circuit 17 configured to execute determination of voltage and current on the basis of the control input signal, the voltage and current control circuit 17 configured to control the output voltage Vo and the output current Io.

In addition, also in the PD device 4 according to the first embodiment, a plurality of other AC coupling capacitors for extracting the AC signals superimposed to be input into the power line output (VBUS) from the outside may be connected between the signal conversion circuit 25 and the power line output (VBUS). In such a case, there will be required the separating inductance LF. More specifically, since it is required to separate the control input signal from the power line output (VBUS) in order that the control input signal is not input into the DC/DC converter 13, there will be required a filter circuit including the inductance LF and the capacitor CF. Thus, also in the PD device 4 according to the first embodiment, the power line output (VBUS)/AC superposition mode may be used in conjunction with the power line output (VBUS)/AC separation mode.

### Modified Examples

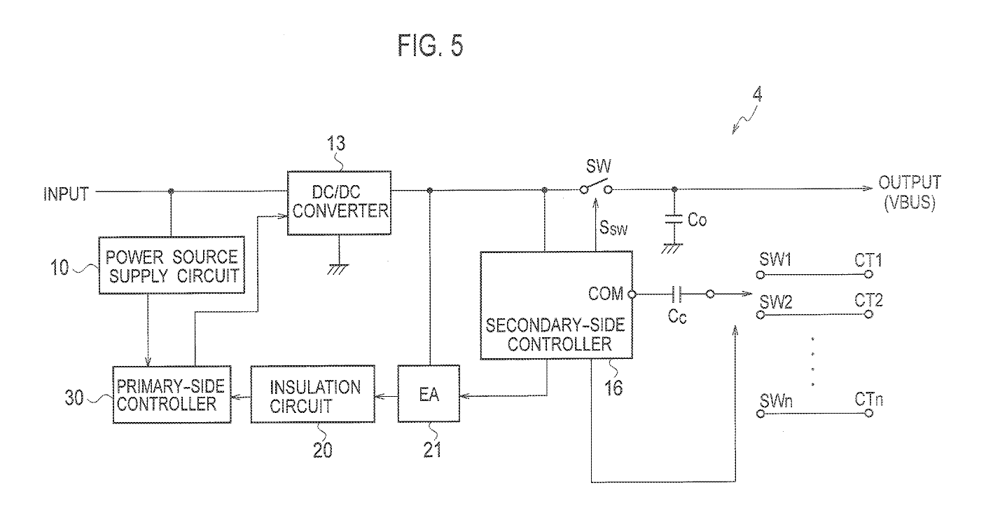

As shown in FIG. 5, a PD device 4 according to a modified example 1 of the first embodiment includes a plurality of switches SW1, SW2, . . . , SWn instead of the signal conversion circuit 25. The switches SW1, SW2, . . . , SWn can be switched both automatically and manually.

Moreover, the plurality of the switches SW1, SW2, . . . , SWn may be controlled by the secondary-side controller 16, in the PD device 4 according to the modified example 1 of the first embodiment. Other configurations are the same as those of the first embodiment.

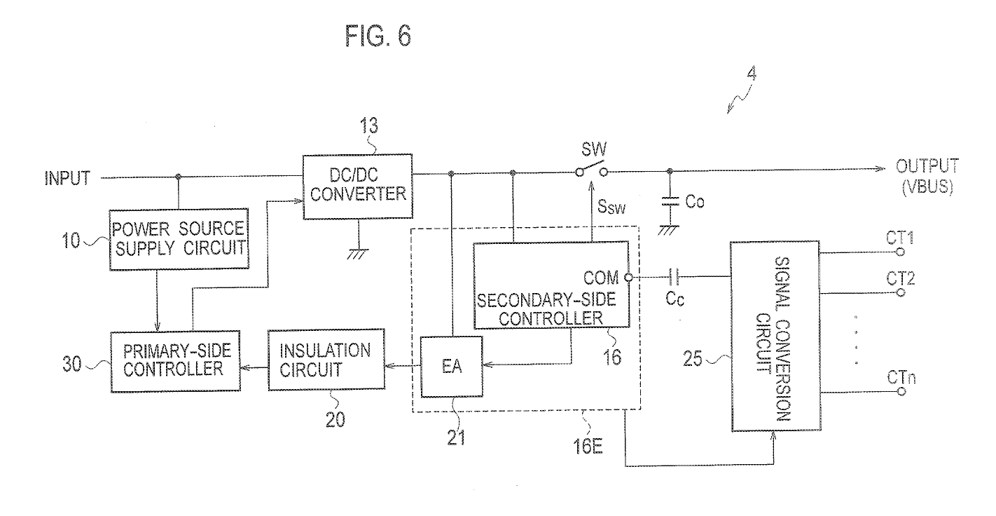

A PD device 4 according to a modified example 2 of the first embodiment may include a secondary-side controller 16E in which the error amplifier 21 is contained, as shown in FIG. 6. More specifically, as shown in FIG. 6, the secondary-side controller 16E and the error amplifier 21 may be integrally formed with each other. In such a case, the signal conversion circuit 25 may be controlled by the secondary-side controller 16E.

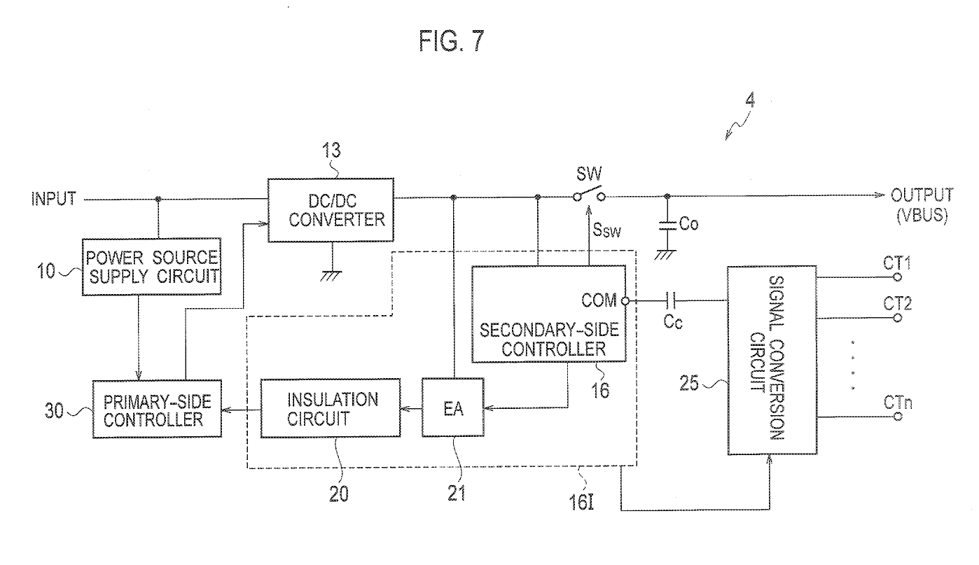

Moreover, a PD device 4 according to a modified example 3 of the first embodiment may include a secondary-side controller 16I in which the error amplifier 21 and the insulation circuit 20 are contained, as shown in FIG. 7. More specifically, as shown in FIG. 7, the secondary-side controller 16I, the error amplifier 21, and the insulation circuit 20 may be integrally formed with one another. In such a case, the signal conversion circuit 25 may be controlled by the secondary-side controller 16I.

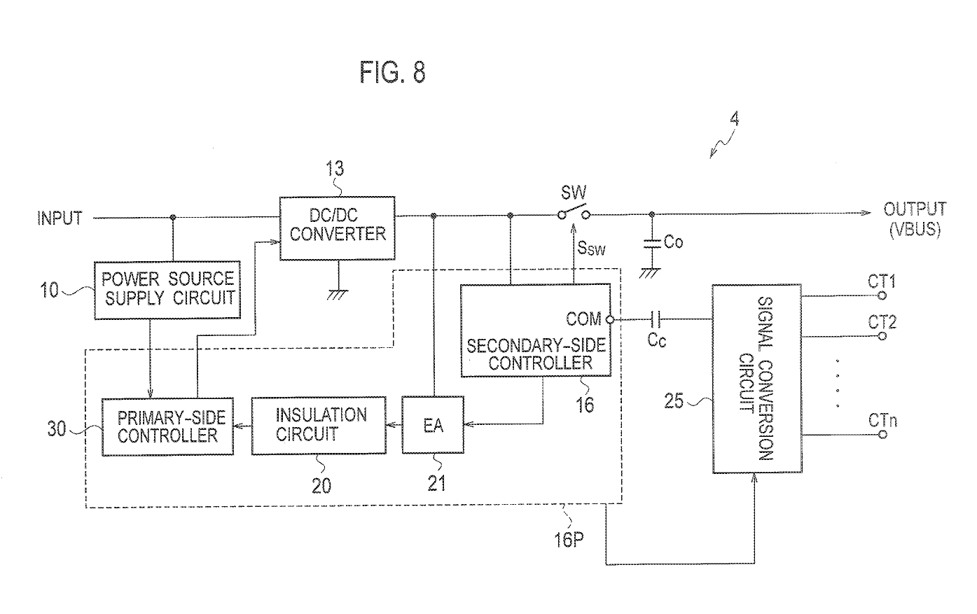

Moreover, a PD device 4 according to a modified example 4 of the first embodiment may include a secondary-side controller 16P in which the error amplifier 21, the insulation circuit 20, and the primary-side controller 30 are contained, as shown in FIG. 8. More specifically, as shown in FIG. 8, the secondary-side controller 16P, the error amplifier 21, the insulation circuit 20, and the primary-side controller 30 may be integrally formed with one another. In such a case, the signal conversion circuit 25 may be controlled by the secondary-side controller 16P.

According to the first embodiment and its modified examples, there can be provided the PD device capable of switching with respect to the plurality of apparatuses, and capable of controlling the output voltage value and the available output current capacity (MAX value).

### Second Embodiment

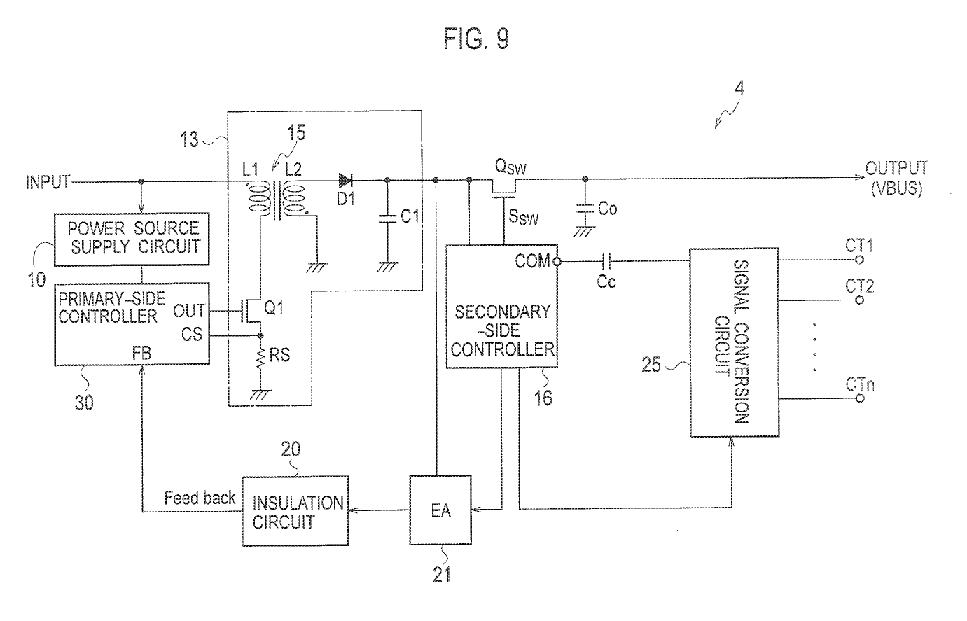

As shown in FIG. 9, a PD device 4 according to a second embodiment includes: a DC/DC converter 13 disposed between an input and an output; a primary-side controller 30 configured to control an input current of the DC/DC converter 13; a signal conversion circuit 25 coupled to a plurality of control inputs, the signal conversion circuit 25 configured to switch a control input signal of a plurality of control inputs; and a secondary-side controller 16 coupled to the signal conversion circuit 25, the secondary-side controller 16 configured to receive the control input signal switched in the signal conversion circuit 25, and then feed back the received control input signal to the primary-side controller 30.

The control input signal switched in the signal conversion circuit 25 is input into a communication terminal COM of the secondary-side controller 16. Moreover, the primary-side controller 30 varies an output voltage value and an available output current capacity (MAX value) of the DC/DC converter 13 by controlling the input current of the DC/DC converter 13 on the basis of the control input signal fed back from the secondary-side controller 16.

Moreover, as shown in FIG. 9, there may be included a plurality of control terminals CT1, CT2, . . . , CTn, and a plurality of the control inputs may be coupled to the plurality of the controls terminals CT1, CT2, . . . , CTn. Moreover, a control output signal of the PD device 4 according to the second embodiment can be output to an external apparatus through the plurality of the control terminals CT1, CT2, . . . , CTn.

In the PD device 4 according to the second embodiment, the DC/DC converter 13 is a diode rectification type converter. More specifically, the DC/DC converter 13 includes: a transformer 15; a first MOS transistor Q1 and a current sensing resistor RS each connected in series between the primary-side inductance L1 of the transformer 15 and ground potential; a diode D1 connected between the secondary-side inductance L2 of the transformer 15 and the output; and a first capacitor C1 connected between the output and the ground potential. Moreover, an output capacitor CO is connected between the power line output (VBUS) and a ground potential.

Moreover, the PD device 4 according to the second embodiment may include AC coupling capacitors Ct1, Ct2, . . . , Ctn coupled to the plurality of the control inputs, and the signal conversion circuit 25 may be connected to the plurality of the control inputs respectively through the AC coupling capacitors Ct1, Ct2, . . . , Ctn.

Moreover, the plurality of the control inputs may be directly connected to the signal conversion circuit 25. More specifically, the control input signals of the plurality of the control inputs may be directly input to the signal conversion circuit 25 without through the AC coupling capacitors Ct1, Ct2, . . . , Ctn.

Moreover, the PD device 4 according to the second embodiment may include a coupling capacitor CC configured to couple the secondary-side controller 16 and the signal conversion circuit 25 to each other. Moreover, between the secondary-side controller 16 and the signal conversion circuit 25 may be directly connected without through the coupling capacitor CC.

Moreover, in the PD device 4 according to the second embodiment, the signal conversion circuit 25 can execute a frequency conversion, a direct current (DC) level conversion, or an amplitude level conversion, for example.

Moreover, in the PD device 4 according to the second embodiment, the signal conversion circuit 25 may be controlled by the secondary-side controller 16.

Moreover, the PD device according to the second embodiment can also use the control input signal input from the plurality of the control inputs through the AC coupling capacitors Ct1, Ct2, . . . , Ctn for USB PD communications, in the same manner as the basic technology.

Moreover, as shown in FIG. 9, the PD device 4 according to the second embodiment may include a Metal Oxide Semiconductor (MOS) switch QSW connected to the output of the DC/DC converter 13, the MOS switch QSW configured to interrupt an output voltage of the DC/DC converter 13. The output of the DC/DC converter 13 and the power line output (VBUS) can be interrupted by the MOS switch QSW. ON/OFF control for the MOS switch QSW can be executed by the secondary-side controller 16. Other configurations are the same as those of the first embodiment.

In addition, also in the PD device 4 according to the second embodiment, the power line output (VBUS)/AC superposition mode may be used in conjunction with the power line output (VBUS)/AC separation mode.

According to the second embodiment, there can be provided the PD device capable of switching with respect to the plurality of apparatuses, and capable of controlling the output voltage value and the available output current capacity (MAX value).

### Third Embodiment

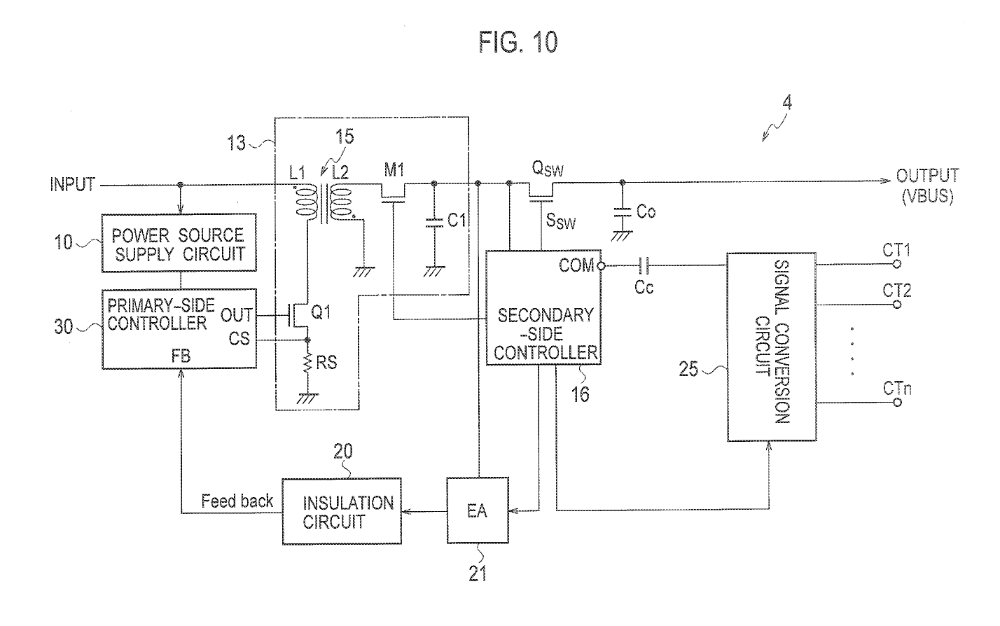

As shown in FIG. 10, a PD device 4 according to a third embodiment includes: a DC/DC converter 13 disposed between an input and an output; a primary-side controller 30 configured to control an input current of the DC/DC converter 13; a signal conversion circuit 25 coupled to a plurality of control inputs, the signal conversion circuit 25 configured to switch a control input signal of a plurality of control inputs; and a secondary-side controller 16 coupled to the signal conversion circuit 25, the secondary-side controller 16 configured to receive the control input signal switched in the signal conversion circuit 25, and then feed back the received control input signal to the primary-side controller 30.

The control input signal switched in the signal conversion circuit 25 is input into a communication terminal COM of the secondary-side controller 16. Moreover, the primary-side controller 30 varies an output voltage value and an available output current capacity (MAX value) of the DC/DC converter 13 by controlling the input current of the DC/DC converter 13 on the basis of the control input signal fed back from the secondary-side controller 16.

Moreover, as shown in FIG. 10, there may be included a plurality of control terminals CT1, CT2, . . . , CTn, and a plurality of the control inputs may be coupled to the plurality of the controls terminals CT1, CT2, . . . , CTn. Moreover, a control output signal of the PD device 4 according to the third embodiment can be output to an external apparatus through the plurality of the control terminals CT1, CT2, . . . , CTn.

In the PD device 4 according to the third embodiment, the DC/DC converter 13 is a synchronous rectification type converter. More specifically, the DC/DC converter 13 includes: a transformer 15; a first MOS transistor Q1 and a current sensing resistor RS each connected in series between the primary-side inductance L1 of the transformer 15 and ground potential; a second MOS transistor M1 connected between the secondary-side inductance L2 of the transformer 15 and the output; and a first capacitor C1 connected between the output and the ground potential. Moreover, an output capacitor CO is connected between the power line output (VBUS) and a ground potential.

Moreover, the PD device 4 according to the third embodiment may include AC coupling capacitors Ct1, Ct2, . . . , Ctn coupled to the plurality of the control inputs, and the signal conversion circuit 25 may be connected to the plurality of the control inputs respectively through the AC coupling capacitors Ct1, Ct2, . . . , Ctn.

Moreover, the plurality of the control inputs may be directly connected to the signal conversion circuit 25. More specifically, the control input signals of the plurality of the control inputs may be directly input to the signal conversion circuit 25 without through the AC coupling capacitors Ct1, Ct2, . . . , Ctn.

Moreover, the PD device 4 according to the third embodiment may include a coupling capacitor CC configured to couple the secondary-side controller 16 and the signal conversion circuit 25 to each other. Moreover, between the secondary-side controller 16 and the signal conversion circuit 25 may be directly connected without through the coupling capacitor CC.

Moreover, in the PD device 4 according to the third embodiment, the signal conversion circuit 25 can execute a frequency conversion, a direct current (DC) level conversion, or an amplitude level conversion, for example.

Moreover, in the PD device 4 according to the third embodiment, the signal conversion circuit 25 may be controlled by the secondary-side controller 16.

Moreover, the PD device according to the third embodiment can also use the control input signal input from the plurality of the control inputs through the AC coupling capacitors Ct1, Ct2, . . . , Ctn for USB PD communications, in the same manner as the basic technology.

In the PD device 4 according to the third embodiment, since the synchronous rectification method is adopted for the DC/DC converter, instead of the diode rectification system, DC/DC power conversion efficiency can be increased, compared with the second embodiment adapting the diode rectification system. Other configurations are the same as those of the first embodiment.

According to the third embodiment, there can be provided the PD device capable of switching with respect to the plurality of apparatuses, and capable of controlling the output voltage value and the available output current capacity (MAX value).

### Fourth Embodiment

As shown in FIG. 11, a PD device 4 according to a fourth embodiment includes an AC/DC converter connected to the AC input, the AC/DC converter including a fuse 11, a choke coil 12, a diode rectification bridge 14, capacitors C5, C6, C3, etc., instead of the power source supply circuit 10 as in the first embodiment.

Moreover, there are included an auxiliary inductance L4 including the primary-side auxiliary winding in the transformer 15, and a diode D2 and a capacitor C4 connected in parallel to the auxiliary inductance L4 therein, and the DC voltage VCC is supplied from the capacitor C4 to the primary-side controller 30.

As shown in FIG. 11, the PD device 4 according to the fourth embodiment includes: a DC/DC converter 13 disposed between an input (DC output of the AC/DC converter) and an output; a primary-side controller 30 configured to control an input current of the DC/DC converter 13; a signal conversion circuit 25 coupled to a plurality of control inputs, the signal conversion circuit 25 configured to switch a control input signal of a plurality of control inputs; and a secondary-side controller 16 coupled to the signal conversion circuit 25, the secondary-side controller 16 configured to receive the control input signal switched in the signal conversion circuit 25, and then feed back the received control input signal to the primary-side controller 30.

The control input signal switched in the signal conversion circuit 25 is input into a communication terminal COM of the secondary-side controller 16. Moreover, the primary-side controller 30 varies an output voltage value and an available output current capacity (MAX value) of the DC/DC converter 13 by controlling the input current of the DC/DC converter 13 on the basis of the control input signal fed back from the secondary-side controller 16.

Moreover, as shown in FIG. 11, there may be included a plurality of control terminals CT1, CT2, . . . , CTn, and a plurality of the control inputs may be coupled to the plurality of the controls terminals CT1, CT2, . . . , CTn. Moreover, a control output signal of the PD device 4 according to the fourth embodiment can be output to an external apparatus through the plurality of the control terminals CT1, CT2, . . . , CTn.

Although PDDET1, PDDET2 from USB receptacle are described on the secondary-side controller 16, the PDDET1, PDDET2 may be omitted.

In the PD device 4 according to the fourth embodiment, the DC/DC converter 13 is a diode rectification type converter. More specifically, the DC/DC converter 13 includes: a transformer 15; a first MOS transistor Q1 and a current sensing resistor RS each connected in series between the primary-side inductance L1 of the transformer 15 and ground potential; a diode D1 connected between the secondary-side inductance L2 of the transformer 15 and the output; and a first capacitor C1 connected between the output and the ground potential.

Moreover, an output capacitor CO is connected between the power line output (VBUS) and a communication terminal COM2 of the secondary-side controller 16, and thereby an AC signal superimposed on the power line output (VBUS) can be input.

Moreover, the PD device 4 according to the fourth embodiment may include AC coupling capacitors Ct1, Ct2, . . . , Ctn coupled to the plurality of the control inputs, and the signal conversion circuit 25 may be connected to the plurality of the control inputs respectively through the AC coupling capacitors Ct1, Ct2, . . . , Ctn.

Moreover, the plurality of the control inputs may be directly connected to the signal conversion circuit 25. More specifically, the control input signals of the plurality of the control inputs may be directly input to the signal conversion circuit 25 without through the AC coupling capacitors Ct1, Ct2, . . . , Ctn.

Moreover, the PD device 4 according to the fourth embodiment may include a coupling capacitor CC configured to couple the secondary-side controller 16 and the signal conversion circuit 25 to each other. Moreover, between the secondary-side controller 16 and the signal conversion circuit 25 may be directly connected without through the coupling capacitor CC.

Moreover, in the PD device 4 according to the fourth embodiment, the signal conversion circuit 25 can execute a frequency conversion, a direct current (DC) level conversion, or an amplitude level conversion, for example.

Moreover, in the PD device 4 according to the fourth embodiment, the signal conversion circuit 25 may be controlled by the secondary-side controller 16.

Although a filter circuit including an inductance LF and a capacitor CF is illustrated in FIG. 11, such a filter circuit is not necessarily required therefor.

Since the plurality of the control inputs are included therein in addition to the power line output (VBUS), mounting space can be relatively reduced, and therefore miniaturization and cost reduction can be realized, in the PD device 4 according to the fourth embodiment.

Moreover, the PD device according to the fourth embodiment can also use the control input signal input from the plurality of the control inputs through the AC coupling capacitors Ct1, Ct2, . . . , Ctn for USB PD communications, in the same manner as the basic technology. Other configurations are the same as those of the second embodiment.

According to the fourth embodiment, there can be provided the PD device capable of switching with respect to the plurality of apparatuses, and capable of controlling the output voltage value and the available output current capacity (MAX value).

### Fifth Embodiment

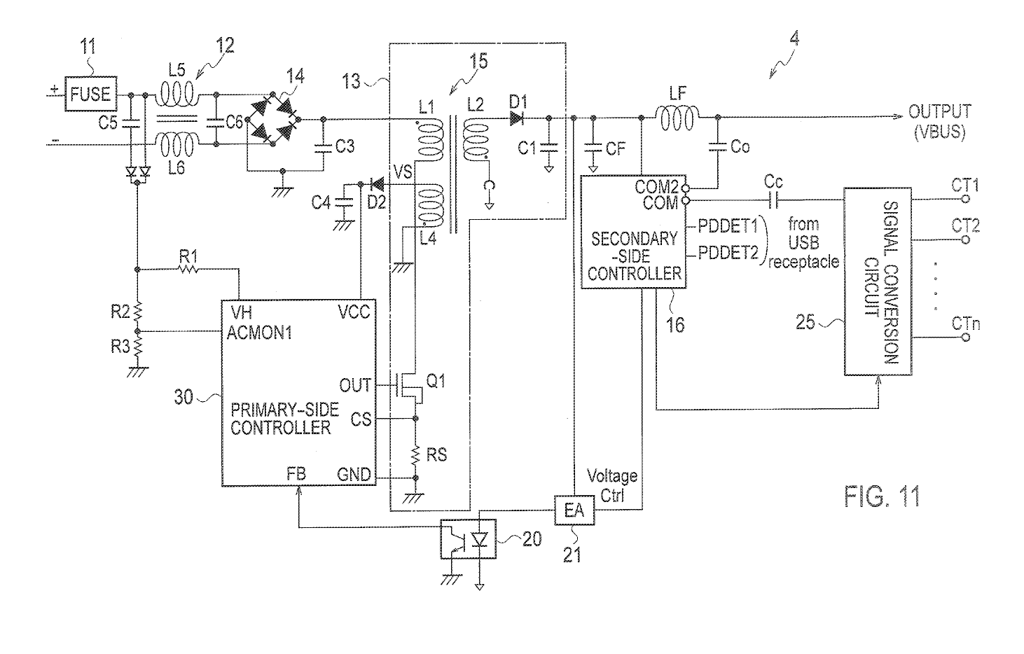

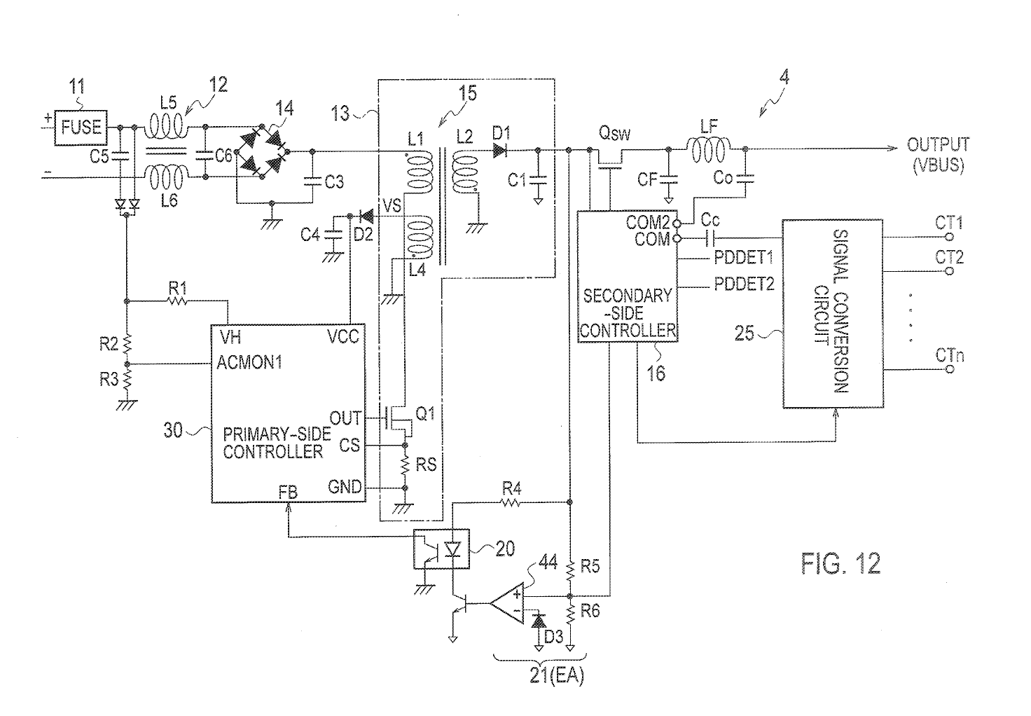

As shown in FIG. 12, a PD device 4 according to a fifth embodiment includes an AC/DC converter connected to an AC input, the AC/DC converter including a fuse 11, a choke coil 12, a diode rectification bridge 14, capacitors C5, C6, C3, instead of the power source supply circuit 10 in the first embodiment.

Moreover, there are included an auxiliary inductance L4 including the primary-side auxiliary winding in the transformer 15, and a diode D2 and a capacitor C4 connected in parallel to the auxiliary inductance L4 therein, and the DC voltage VCC is supplied from the capacitor C4 to the primary-side controller 30.

As shown in FIG. 12, the PD device 4 according to the fifth embodiment includes: a DC/DC converter 13 disposed between an input (DC output of the AC/DC converter) and an output; a primary-side controller 30 configured to control an input current of the DC/DC converter 13; a signal conversion circuit 25 coupled to a plurality of control inputs, the signal conversion circuit 25 configured to switch a control input signal of a plurality of control inputs; and a secondary-side controller 16 coupled to the signal conversion circuit 25, the secondary-side controller 16 configured to receive the control input signal switched in the signal conversion circuit 25, and then feed back the received control input signal to the primary-side controller 30.

The control input signal switched in the signal conversion circuit 25 is input into a communication terminal COM of the secondary-side controller 16. Moreover, the primary-side controller 30 varies an output voltage value and an available output current capacity (MAX value) of the DC/DC converter 13 by controlling the input current of the DC/DC converter 13 on the basis of the control input signal fed back from the secondary-side controller 16.

Moreover, as shown in FIG. 12, there may be included a plurality of control terminals CT1, CT2, . . . , CTn, and a plurality of the control inputs may be coupled to the plurality of the controls terminals CT1, CT2, . . . , CTn. Moreover, a control output signal of the PD device 4 according to the fifth embodiment can be output to an external apparatus through the plurality of the control terminals CT1, CT2, . . . , CTn.

Although PDDET1, PDDET2 from USB receptacle are described on the secondary-side controller 16, the PDDET1, PDDET2 may be omitted.

In the PD device 4 according to the fifth embodiment, the DC/DC converter 13 is a diode rectification type converter. More specifically, the DC/DC converter 13 includes: a transformer 15; a first MOS transistor Q1 and a current sensing resistor RS each connected in series between the primary-side inductance L1 of the transformer 15 and ground potential; a diode D1 connected between the secondary-side inductance L2 of the transformer 15 and the output; and a first capacitor C1 connected between the output and the ground potential.

Moreover, an output capacitor CO is connected between the power line output (VBUS) and a communication terminal COM2 of the secondary-side controller 16, and thereby an AC signal superimposed on the power line output (VBUS) can be input.

Moreover, the PD device 4 according to the fifth embodiment may include AC coupling capacitors Ct1, Ct2, . . . , Ctn coupled to the plurality of the control inputs, and the signal conversion circuit 25 may be connected to the plurality of the control inputs respectively through the AC coupling capacitors Ct1, Ct2, . . . , Ctn.

Moreover, the plurality of the control inputs may be directly connected to the signal conversion circuit 25. More specifically, the control input signals of the plurality of the control inputs may be directly input to the signal conversion circuit 25 without through the AC coupling capacitors Ct1, Ct2, . . . , Ctn.

Moreover, as shown in FIG. 12, the PD device 4 according to the fifth embodiment may include the insulation circuit 20 connected to the secondary-side controller 16, the insulation circuit 20 configured to feed back the control input signal to the primary-side controller 30.

Moreover, as shown in FIG. 12, the PD device 4 according to the fifth embodiment may include the error amplifier 21 for error compensation connected to the secondary-side controller 16, the error amplifier 21 configured to feed back the control input signal to the insulation circuit 20. In the present embodiment, as shown in FIG. 12, the error amplifier 21 includes discrete components, e.g. a power amplifier 44, a diode D3, and resistors R5, R6.

Moreover, the PD device 4 according to the fifth embodiment may include a coupling capacitor CC configured to couple the secondary-side controller 16 and the signal conversion circuit 25 to each other. Moreover, between the secondary-side controller 16 and the signal conversion circuit 25 may be directly connected without through the coupling capacitor CC.

Moreover, in the PD device 4 according to the fifth embodiment, the signal conversion circuit 25 can execute a frequency conversion, a direct current (DC) level conversion, or an amplitude level conversion, for example.

Moreover, in the PD device 4 according to the fifth embodiment, the signal conversion circuit 25 may be controlled by the secondary-side controller 16.

Although a filter circuit including an inductance LF and a capacitor CF is illustrated in FIG. 12, such a filter circuit is not necessarily required therefor.

Since the plurality of the control inputs are included therein in addition to the power line output (VBUS), mounting space can be relatively reduced, and therefore miniaturization and cost reduction can be realized, in the PD device 4 according to the fifth embodiment.

Moreover, the PD device according to the fifth embodiment can also use the control input signal input from the plurality of the control inputs through the AC coupling capacitors Ct1, Ct2, . . . , Ctn for USB PD communications, in the same manner as the basic technology.

Moreover, as shown in FIG. 12, the PD device 4 according to the fifth embodiment may include a MOS switch QSW connected to the output of the DC/DC converter 13, the MOS switch QSW configured to interrupt an output voltage of the DC/DC converter 13. The output of the DC/DC converter 13 and the power line output (VBUS) can be interrupted by the MOS switch QSW. ON/OFF control for the MOS switch QSW can be executed by the secondary-side controller 16. Other configurations are the same as those of the second embodiment.

According to the fifth embodiment, there can be provided the PD device capable of switching with respect to the plurality of apparatuses, and capable of controlling the output voltage value and the available output current capacity (MAX value).

### Sixth Embodiment

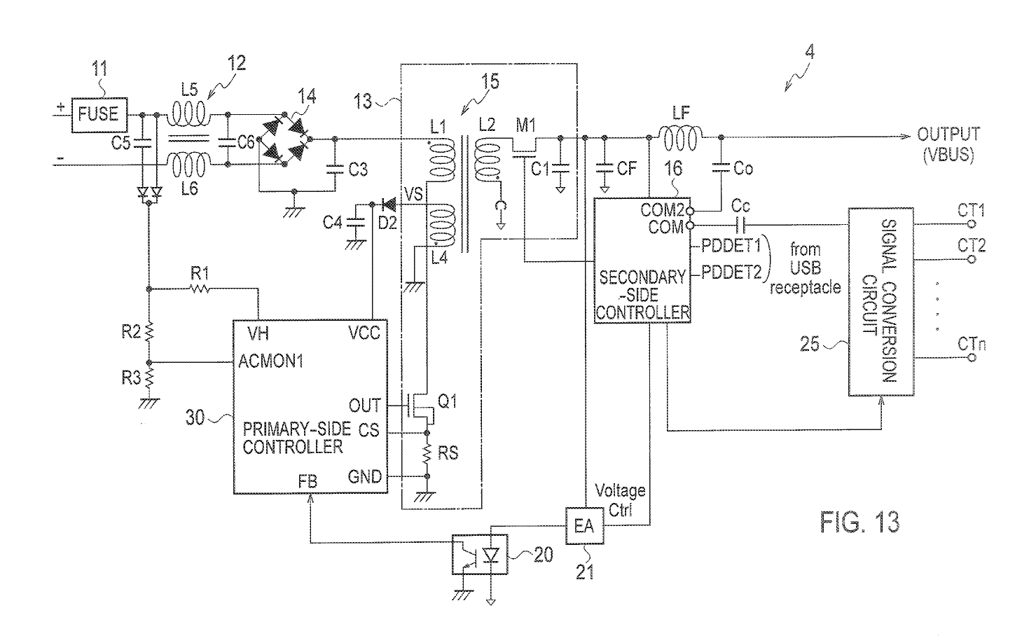

As shown in FIG. 13, a PD device 4 according to a sixth embodiment includes an AC/DC converter connected to an AC input, the AC/DC converter including a fuse 11, a choke coil 12, a diode rectification bridge 14, capacitors C5, C6, C3, instead of the power source supply circuit 10 in the first embodiment.

Moreover, there are included an auxiliary inductance L4 including the primary-side auxiliary winding in the transformer 15, and a diode D2 and a capacitor C4 connected in parallel to the auxiliary inductance L4 therein, and the DC voltage VCC is supplied from the capacitor C4 to the primary-side controller 30.

As shown in FIG. 13, the PD device 4 according to the sixth embodiment includes: a DC/DC converter 13 disposed between an input (DC output of the AC/DC converter) and an output; a primary-side controller 30 configured to control an input current of the DC/DC converter 13; a signal conversion circuit 25 coupled to a plurality of control inputs, the signal conversion circuit 25 configured to switch a control input signal of a plurality of control inputs; and a secondary-side controller 16 coupled to the signal conversion circuit 25, the secondary-side controller 16 configured to receive the control input signal switched in the signal conversion circuit 25, and then feed back the received control input signal to the primary-side controller 30.

The control input signal switched in the signal conversion circuit 25 is input into a communication terminal COM of the secondary-side controller 16. Moreover, the primary-side controller 30 varies an output voltage value and an available output current capacity (MAX value) of the DC/DC converter 13 by controlling the input current on the basis of the control input signal fed back from the secondary-side controller 16.

Moreover, as shown in FIG. 13, there may be included a plurality of control terminals CT1, CT2, . . . , CTn, and a plurality of the control inputs may be coupled to the plurality of the controls terminals CT1, CT2, . . . , CTn. Moreover, a control output signal of the PD device 4 according to the sixth embodiment can be output to an external apparatus through the plurality of the control terminals CT1, CT2, . . . , CTn.

Although PDDET1, PDDET2 from USB receptacle are described on the secondary-side controller 16, the PDDET1, PDDET2 may be omitted.

In the PD device 4 according to the sixth embodiment, the DC/DC converter 13 is a synchronous rectification type converter. More specifically, the DC/DC converter 13 includes: a transformer 15; a first MOS transistor Q1 and a current sensing resistor RS each connected in series between the primary-side inductance L1 of the transformer 15 and ground potential; a second MOS transistor M1 connected between the secondary-side inductance L2 of the transformer 15 and the output; and a first capacitor C1 connected between the output and the ground potential.

Moreover, an output capacitor CO is connected between the power line output (VBUS) and a communication terminal COM2 of the secondary-side controller 16, and thereby an AC signal superimposed on the power line output (VBUS) can be input.

Moreover, the PD device 4 according to the sixth embodiment may include AC coupling capacitors Ct1, Ct2, . . . , Ctn coupled to the plurality of the control inputs, and the signal conversion circuit 25 may be connected to the plurality of the control inputs respectively through the AC coupling capacitors Ct1, Ct2, . . . , Ctn.

Moreover, the plurality of the control inputs may be directly connected to the signal conversion circuit 25. More specifically, the control input signals of the plurality of the control inputs may be directly input to the signal conversion circuit 25 without through the AC coupling capacitors Ct1, Ct2, . . . , Ctn.

Moreover, the PD device 4 according to the sixth embodiment may include a coupling capacitor CC configured to couple the secondary-side controller 16 and the signal conversion circuit 25 to each other. Moreover, between the secondary-side controller 16 and the signal conversion circuit 25 may be directly connected without through the coupling capacitor CC.

Moreover, in the PD device 4 according to the sixth embodiment, the signal conversion circuit 25 can execute a frequency conversion, a direct current (DC) level conversion, or an amplitude level conversion, for example.

Moreover, in the PD device 4 according to the sixth embodiment, the signal conversion circuit 25 may be controlled by the secondary-side controller 16.

Although a filter circuit including an inductance LF and a capacitor CF is illustrated in FIG. 13, such a filter circuit is not necessarily required therefor.

Since the plurality of the control inputs are included therein in addition to the power line output (VBUS), mounting space can be relatively reduced, and therefore miniaturization and cost reduction can be realized, in the PD device 4 according to the sixth embodiment.

Moreover, the PD device according to the sixth embodiment can also use the control input signal input from the plurality of the control inputs through the AC coupling capacitors Ct1, Ct2, . . . , Ctn for USB PD communications, in the same manner as the basic technology.

In the PD device 4 according to the sixth embodiment, since the synchronous rectification method is adopted for the DC/DC converter, instead of the diode rectification system, DC/DC power conversion efficiency can be increased, compared with the second, fourth, and fifth embodiments adapting the diode rectification system. Other configurations are the same as those of the third embodiment.

According to the sixth embodiment, there can be provided the PD device capable of switching with respect to the plurality of apparatuses, and capable of controlling the output voltage value and the available output current capacity (MAX value).

### Seventh Embodiment

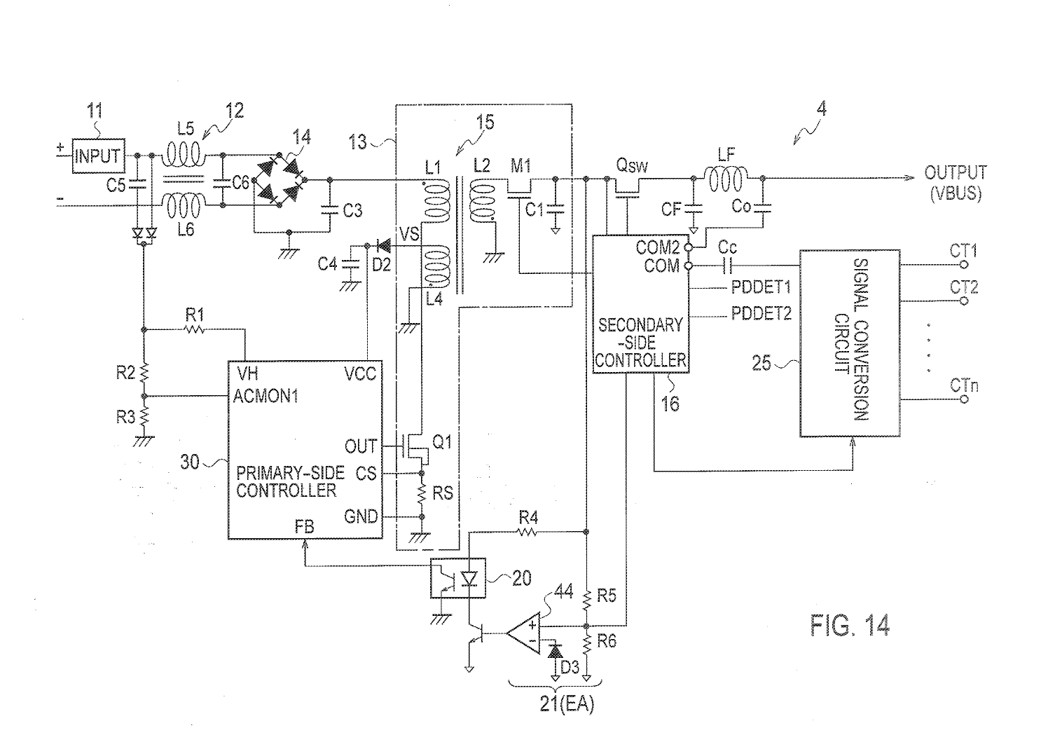

As shown in FIG. 14, a PD device 4 according to a seventh embodiment includes an AC/DC converter connected to an AC input, the AC/DC converter 300 including a fuse 11, a choke coil 12, a diode rectification bridge 14, capacitors C5, C6, C3, instead of the power source supply circuit 10 as in the third embodiment, in the same manner as the sixth embodiment.

Moreover, there are included an auxiliary inductance L4 including the primary-side auxiliary winding in the transformer 15, and a diode D2 and a capacitor C4 connected in parallel to the auxiliary inductance L4 therein, and the DC voltage VCC is supplied from the capacitor C4 to the primary-side controller 30.

As shown in FIG. 14, the PD device 4 according to the seventh embodiment includes: a DC/DC converter 13 disposed between an input (DC output of the AC/DC converter) and an output; a primary-side controller 30 configured to control an input current of the DC/DC converter 13; a signal conversion circuit 25 coupled to a plurality of control inputs, the signal conversion circuit 25 configured to switch a control input signal of a plurality of control inputs; and a secondary-side controller 16 coupled to the signal conversion circuit 25, the secondary-side controller 16 configured to receive the control input signal switched in the signal conversion circuit 25, and then feed back the received control input signal to the primary-side controller 30.

The control input signal switched in the signal conversion circuit 25 is input into a communication terminal COM of the secondary-side controller 16. Moreover, the primary-side controller 30 varies an output voltage value and an available output current capacity (MAX value) of the DC/DC converter 13 by controlling the input current on the basis of the control input signal fed back from the secondary-side controller 16.

Moreover, as shown in FIG. 13, there may be included a plurality of control terminals CT1, CT2, . . . , CTn, and a plurality of the control inputs may be coupled to the plurality of the controls terminals CT1, CT2, . . . , CTn. Moreover, a control output signal of the PD device 4 according to the seventh embodiment can be output to an external apparatus through the plurality of the control terminals CT1, CT2, . . . , CTn.

Although PDDET1, PDDET2 are described on the secondary-side controller 16, the PDDET1, PDDET2 may be omitted.

In the PD device 4 according to the seventh embodiment, the DC/DC converter 13 is a synchronous rectification type converter. More specifically, the DC/DC converter 13 includes: a transformer 15; a first MOS transistor Q1 and a current sensing resistor RS each connected in series between the primary-side inductance L1 of the transformer 15 and ground potential; a second MOS transistor M1 connected between the secondary-side inductance L2 of the transformer 15 and the output; and a first capacitor C1 connected between the output and the ground potential.

Moreover, an output capacitor CO is connected between the power line output (VBUS) and a communication terminal COM2 of the secondary-side controller 16, and thereby an AC signal superimposed on the power line output (VBUS) can be input.

Moreover, the PD device 4 according to the seventh embodiment may include AC coupling capacitors Ct1, Ct2, . . . , Ctn coupled to the plurality of the control inputs, and the signal conversion circuit 25 may be connected to the plurality of the control inputs respectively through the AC coupling capacitors Ct1, Ct2, . . . , Ctn.

Moreover, the plurality of the control inputs may be directly connected to the signal conversion circuit 25. More specifically, the control input signals of the plurality of the control inputs may be directly input to the signal conversion circuit 25 without through the AC coupling capacitors Ct1, Ct2, . . . , Ctn.

Moreover, as shown in FIG. 14, the PD device 4 according to the seventh embodiment may include the insulation circuit 20 connected to the secondary-side controller 16, the insulation circuit 20 configured to feed back the control input signal to the primary-side controller 30.

Moreover, as shown in FIG. 14, the PD device 4 according to the seventh embodiment may include the error amplifier 21 for error compensation connected to the secondary-side controller 16, the error amplifier 21 configured to feed back the control input signal to the insulation circuit 20. In the present embodiment, as shown in FIG. 14, the error amplifier 21 includes discrete components, e.g. a power amplifier 44, a diode D3, and resistors R5, R6.

Moreover, the PD device 4 according to the seventh embodiment may include a coupling capacitor CC configured to couple the secondary-side controller 16 and the signal conversion circuit 25 to each other. Moreover, between the secondary-side controller 16 and the signal conversion circuit 25 may be directly connected without through the coupling capacitor CC.

Moreover, in the PD device 4 according to the seventh embodiment, the signal conversion circuit 25 can execute a frequency conversion, a direct current (DC) level conversion, or an amplitude level conversion, for example.

Moreover, in the PD device 4 according to the seventh embodiment, the signal conversion circuit 25 may be controlled by the secondary-side controller 16.

Although a filter circuit including an inductance LF and a capacitor CF is illustrated in FIG. 14, such a filter circuit is not necessarily required therefor.

Since the plurality of the control inputs are included therein in addition to the power line output (VBUS), mounting space can be relatively reduced, and therefore miniaturization and cost reduction can be realized, in the PD device 4 according to the seventh embodiment.

Moreover, the PD device according to the seventh embodiment can also use the control input signal input from the plurality of the control inputs through the AC coupling capacitors Ct1, Ct2, . . . , Ctn for USB PD communications, in the same manner as the basic technology.

In the PD device 4 according to the seventh embodiment, since the synchronous rectification method is adopted for the DC/DC converter, instead of the diode rectification system, DC/DC power conversion efficiency can be increased, compared with the second, fourth, and fifth embodiments adapting the diode rectification system.

Moreover, as shown in FIG. 14, the PD device 4 according to the seventh embodiment may include a MOS switch QSW connected to the output of the DC/DC converter 13, the MOS switch QSW configured to interrupt an output voltage of the DC/DC converter 13. The output of the DC/DC converter 13 and the power line output (VBUS) can be interrupted by the MOS switch QSW. ON/OFF control for the MOS switch QSW can be executed by the secondary-side controller 16. Other configurations are the same as those of the sixth embodiment.

According to the seventh embodiment, there can be provided the PD device capable of switching with respect to the plurality of apparatuses, and capable of controlling the output voltage value and the available output current capacity (MAX value).

### Eighth Embodiment

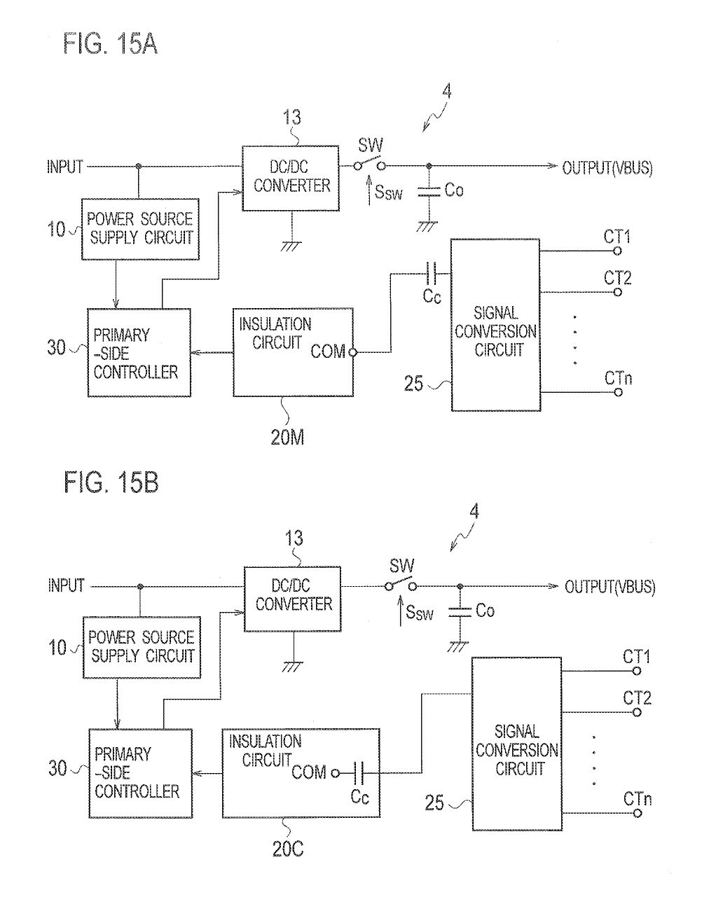

As shown in FIG. 15A, a PD device 4 according to an eighth embodiment includes: a DC/DC converter 13 disposed between an input and an output; a primary-side controller 30 configured to control an input current of the DC/DC converter 13; a signal conversion circuit 25 coupled to a plurality of control inputs, the signal conversion circuit 25 configured to switch a control input signal of a plurality of control inputs; and an insulation circuit 20M coupled to the signal conversion circuit 25, the insulation circuit 20M configured to receive the control input signal switched in the signal conversion circuit 25, and then feed back the received control input signal to the primary-side controller 30. In the present embodiment, the control input signal switched in the signal conversion circuit 25 is input into a communication terminal COM of the insulation circuit 20M. Moreover, the primary-side controller 30 varies an output voltage value and an available output current capacity (MAX value) of the DC/DC converter 13 by controlling the input current of the DC/DC converter 13 on the basis of the control input signal fed back from the insulation circuit 20M.

Moreover, as shown in FIG. 15A, there may be included a plurality of control terminals CT1, CT2, . . . , CTn, and a plurality of the control inputs may be coupled to the plurality of the controls terminals CT1, CT2, . . . , CTn. Moreover, a control output signal of the PD device 4 according to the eighth embodiment can be output to an external apparatus through the plurality of the control terminals CT1, CT2, . . . , CTn.

Moreover, the PD device 4 according to the eighth embodiment may include AC coupling capacitors Ct1, Ct2, . . . , Ctn coupled to the plurality of the control inputs, and the signal conversion circuit 25 may be connected to the plurality of the control inputs respectively through the AC coupling capacitors Ct1, Ct2, . . . , Ctn.

Moreover, the plurality of the control inputs may be directly connected to the signal conversion circuit 25. More specifically, the control input signals of the plurality of the control inputs may be directly input to the insulation circuit 20M without through the AC coupling capacitors Ct1, Ct2, . . . , Ctn.

Moreover, as shown in FIG. 15A, the secondary-side controller and the error amplifier are removed from the PD device 4 according to the eighth embodiment.

Moreover, the PD device 4 according to the eighth embodiment may include a coupling capacitor CC configured to couple the insulation circuit 20M and the signal conversion circuit 25 to each other. Moreover, between the insulation circuit 20M and the signal conversion circuit 25 may be directly connected without through the coupling capacitor CC. A capacitor, a photo coupler, a transformer, etc. is applicable to the insulation circuit 20M. Moreover, as usage, a bidirectional transformer having an insulated driver, a bilateral device, etc. may also be applied thereto.

Moreover, in the PD device 4 according to the eighth embodiment, the signal conversion circuit 25 can execute a frequency conversion, a direct current (DC) level conversion, or an amplitude level conversion, for example.

Moreover, in the PD device 4 according to the eighth embodiment, the signal conversion circuit 25 may be controlled by the insulation circuit 20 or the primary-side controller 30.

Moreover, the PD device according to the eighth embodiment can also use the control input signal input from the plurality of the control inputs through the AC coupling capacitors Ct1, Ct2, . . . , Ctn for USB PD communications, in the same manner as the basic technology. Other configurations are the same as those of the first embodiment.

### Modified Example

As shown in FIG. 15B, a PD device 4 according to a modified example of the eighth embodiment includes: a DC/DC converter 13 disposed between an input and an output; a primary-side controller 30 configured to control an input current of the DC/DC converter 13; a signal conversion circuit 25 coupled to a plurality of control inputs, the signal conversion circuit 25 configured to switch a control input signal of a plurality of control inputs; and an insulation circuit 20C coupled to the signal conversion circuit 25, the insulation circuit 20C configured to receive the control input signal switched in the signal conversion circuit 25, and then feed back the received control input signal to the primary-side controller 30. In the present example, the control input signal switched in the signal conversion circuit 25 is input into a communication terminal COM provided in the insulation circuit 20C. Moreover, the primary-side controller 30 varies an output voltage value and an available output current capacity (MAX value) of the DC/DC converter 13 by controlling the input current of the DC/DC converter 13 on the basis of the control input signal fed back from the insulation circuit 20C.

Moreover, as shown in FIG. 15B, there may be included a plurality of control terminals CT1, CT2, . . . , CTn, and a plurality of the control inputs may be coupled to the plurality of the controls terminals CT1, CT2, . . . , CTn. Moreover, a control output signal of the PD device 4 according to the modified example of the eighth embodiment can be output to an external apparatus through the plurality of the control terminals CT1, CT2, . . . , CTn.

Moreover, as shown in FIG. 15B, the secondary-side controller and the error amplifier are removed from the PD device 4 according to the modified example of the eighth embodiment.

Moreover, as shown in FIG. 15B, the coupling capacitor CC configured to couple the insulation circuit 20C and the signal conversion circuit 25 to each other is contained in the insulation circuit 20C, in the PD device 4 according to the modified example of the eighth embodiment. Other configurations are the same as those of the eighth embodiment.

According to the eighth embodiment and its modified example, there can be provided the PD device capable of switching with respect to the plurality of apparatuses, and capable of controlling the output voltage value and the available output current capacity (MAX value).

### (MOS Switch)

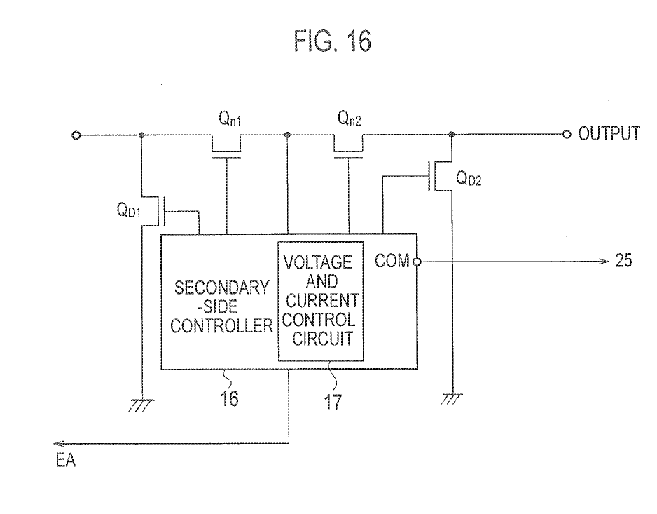

As shown in FIG. 16, a schematic circuit block configuration example of a switch SW applicable to the PD device 4 according to the first or eighth embodiment, or a MOS switch QSW applicable to the PD device according to the second, third, fifth or seventh embodiment includes: two n-channel MOSFETs Qn1, Qn2 connected to each other in series; and MOSFETs QD1, QD2 for discharging respectively connected to both ends of the n channel MOSFETs Qn1, Qn2 connected to each other in series. Each gate of the two n-channel MOSFETs Qn1, Qn2 connected to each other in series is connected to the secondary-side controller 16, and ON/OFF of MOSFETs Qn1, Qn2 is controlled by the secondary-side controller 16. A voltage and current control circuit 17 is contained in the secondary-side controller 16, and the control input signal is input into the communication terminal COM of the secondary-side controller 16.

### (AC Adapter/AC Charger)

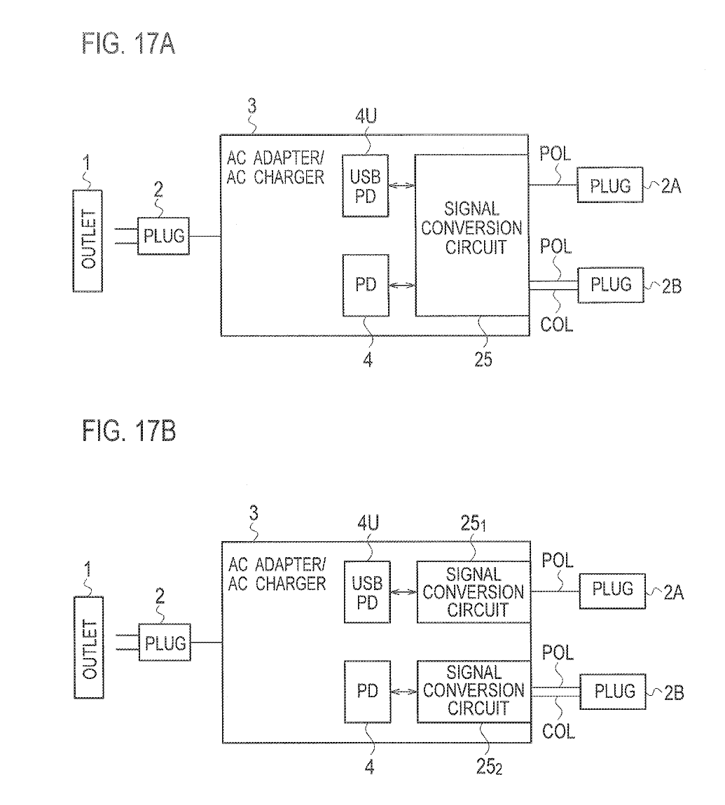

The PD device 4 according to the first to eighth embodiments can be contained in AC adapter/AC charger 3, as shown in FIGS. 17 to 22.

In examples of wire connection for connecting a plug 2 capable of being connected to an outlet 1 to the AC adapter/AC charger 3 using a cable, FIG. 17A shows an example of connecting a signal conversion circuit 25 in the AC adapter/AC charger 3 to external plugs 2A and 2B, and FIG. 17B shows another example.

In FIG. 17A, a control input signal of USB PD 4U and a control input signal of the PD device (PD) 4 according to the embodiments can be switched by the signal conversion circuit 25. The signal conversion circuit 25 can be contained in the PD device (PD) 4.

In FIG. 17A, the signal conversion circuit 25 and the plug 2A are connected to each other by a power line POL, and the signal conversion circuit 25 and the plug 2B are connected to each other by a power line POL and a communication dedicated line COL.

The USB PD 4U and the PD device (PD) 4 can be respectively and bidirectionally connected to the signal conversion circuit 25, as shown in FIG. 17A. In FIG. 17B, the control input signal of the USB PD 4U and the control input signal of the PD device according to the embodiments (PD) 4 can be switched by a plurality of signal conversion circuits 251, 252. The signal conversion circuits 251, 252 can be respectively contained in the USB PD 4U and the PD device (PD) 4.

In FIG. 17B, the signal conversion circuit 251 and the plug 2A are connected to each other by the power line POL, and the signal conversion circuit 252 and the plug 2B are connected to each other by the power line POL and the communication dedicated line COL.

The USB PD 4U and the PD device (PD) 4 can be respectively and bidirectionally connected to the signal conversion circuits 251, 252, as shown in FIG. 17B.

One or a plurality of the signal conversion circuits can be contained in the AC adapter/AC charger 3. In the AC adapter/AC charger 3 simultaneously including the USB PD 4U and the PD device (PD) 4, the number of extraction of the outputs can be variously selected, through such a signal conversion circuit operation. For example, it is possible to set a ratio of the number of extraction in the USB PD 4U and the PD device (PD) 4 as 1:N, 1:1, or N:1, where N is an integer greater than or equal to 2.

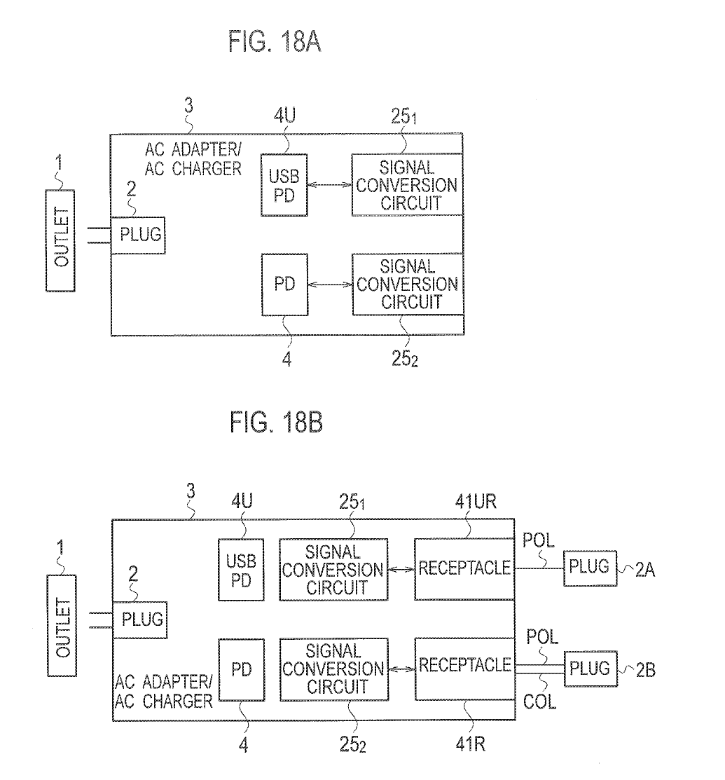

In examples of containing the plug 2 capable of being connected to the outlet 1 in the AC adapter/AC charger 3, FIG. 18A shows an example of including the USB PD 4U and the PD device according to the embodiments (PD) 4 in the AC adapter/AC charger 3, and FIG. 18B shows an example of connecting external plugs 2A, 2B to receptacles 41UR, 41R contained in the AC adapter/AC charger 3.

In FIG. 18A, the control input signal of the USB PD 4U and the control input signal of the PD device (PD) 4 can be switched by the signal conversion circuits 251, 252. The signal conversion circuits 251, 252 can be respectively contained in the USB PD 4U and the PD device (PD) 4.

The USB PD 4U and the PD device (PD) 4 can be respectively and bidirectionally connected to the signal conversion circuits 251, 252, as shown in FIG. 18A.

In FIG. 18B, the control input signal of the receptacle 41UR for the USB PD 4U and the control input signal of the receptacle 41R for the PD device (PD) 4 can be switched by the plurality of the signal conversion circuits 251, 252.

The receptacle 41UR and the plug 2A are connected to each other by the power line POL. The receptacle 41R and the plug 2B are connected to each other by the power line POL and the communication dedicated line COL.

The signal conversion circuits 251, 252 can be respectively and bidirectionally connected to the receptacles 41UR, 41R, as shown in FIG. 18B.

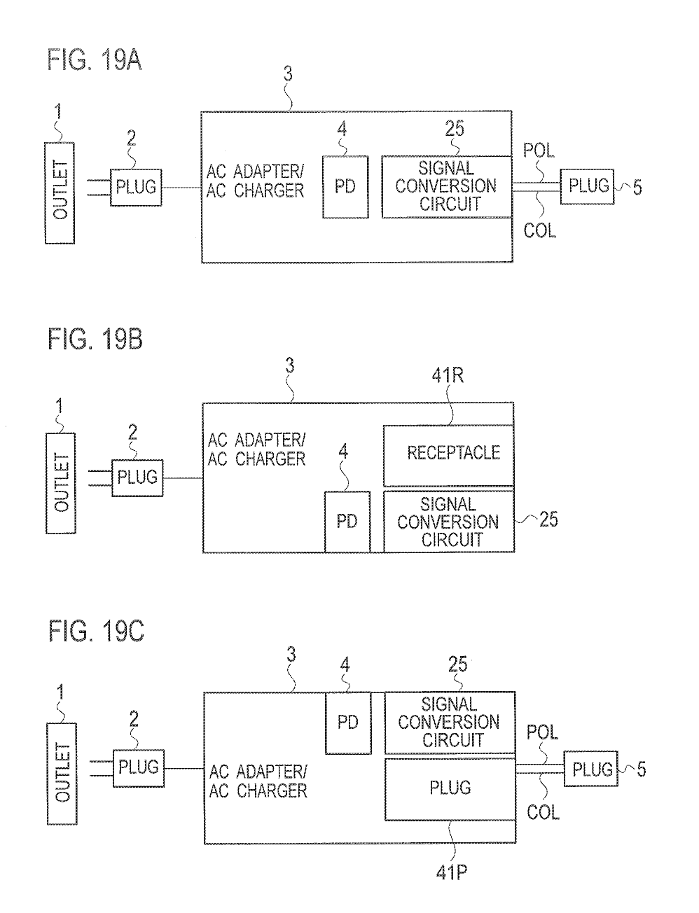

As shown in FIG. 19A, the AC adapter/AC charger 3 containing the PD device (PD) 4 according to the embodiments can be connected to the plug 2 connectable to the outlet 1 using a cable, and can be connected to the plug 5 disposed the outside of the AC adapter/AC charger 3. The signal conversion circuit 25 and the plug 5 are connected to each other by the power line POL and the communication dedicated line COL. In FIG. 19A, the control input signal of the PD device (PD) 4 can be switched by the signal conversion circuit 25. The signal conversion circuit 25 can be contained in the PD device (PD) 4.

Moreover, as shown in FIG. 19B, the AC adapter/AC charger 3 containing the PD device according to the embodiments can be connected to the plug 2 connectable to the outlet 1 using a cable, and may include the receptacle 41R used for the PD device (PD) 4 and the signal conversion circuit 25. In FIG. 19B, the control input signal of the receptacle 41R for the PD device (PD) 4 can be switched by the signal conversion circuit 25.

Moreover, as shown in FIG. 19C, the AC adapter/AC charger 3 containing the PD device according to the embodiments can be connected to the plug 2 connectable to the outlet 1 using a cable, and may include a plug 41P. The plug 41P can be connected to the plug 5 disposed at the outside thereof. The plug 41P and the plug 5 are connected to each other by the power line POL and the communication dedicated line COL. In FIG. 19C, the control input signal of the plug 41P for the PD device (PD) 4 can be switched by the signal conversion circuit 25.

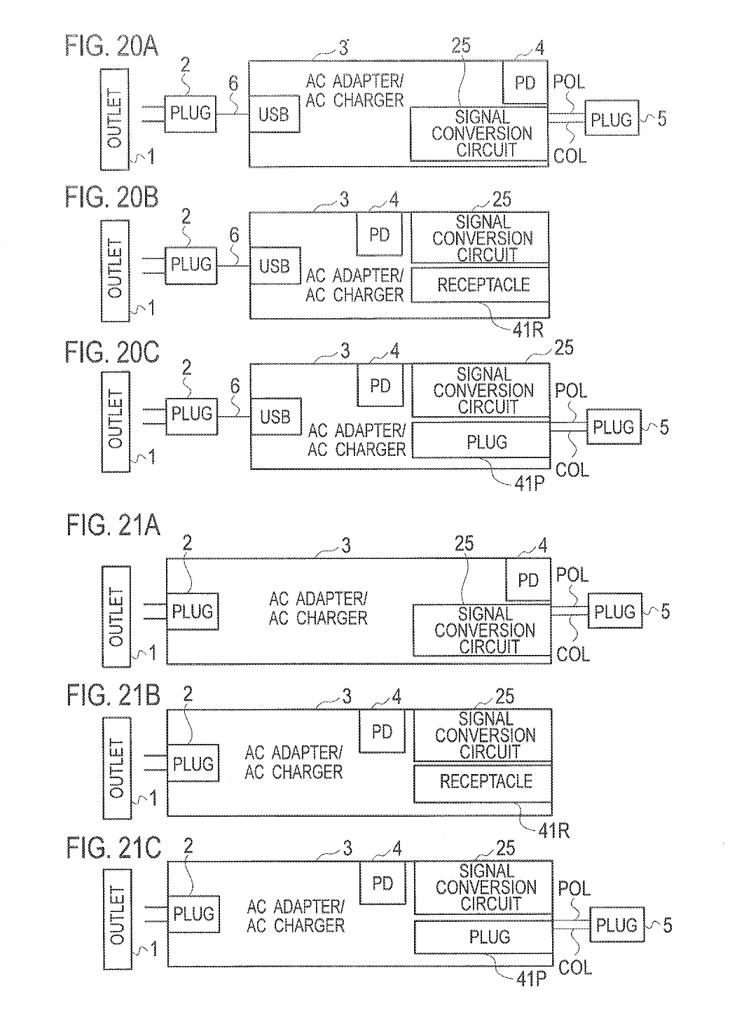

Moreover, as shown in FIG. 20A, the AC adapter/AC charger 3 containing the PD device (PD) 4 according to the embodiments can be connected to the plug 2 connectable to the outlet 1 using a USB PD cable 6, and can also be connected to the plug 5 disposed at the outside of the AC adapter/AC charger 3. The signal conversion circuit 25 and the plug 5 are connected to each other by the power line POL and the communication dedicated line COL. In FIG. 20A, the control input signal of the PD device (PD) 4 can be switched by the signal conversion circuit 25. The signal conversion circuit 25 can be contained in the PD device (PD) 4.

Moreover, as shown in FIG. 20B, the AC adapter/AC charger 3 containing the PD device according to the embodiments can be connected to the plug 2 connectable to the outlet 1 using the USB PD cable 6, and may also include a receptacle 41R. In FIG. 20B, the control input signal of the receptacle 41R for the PD device (PD) 4 can be switched by the signal conversion circuit 25.

Moreover, as shown in FIG. 20C, the AC adapter/AC charger 3 containing the PD device according to the embodiments may be connected to the plug 2 connectable to the outlet 1 using the USB PD cable 6, and may also include a plug 41P. The plug 41P can be connected to the plug 5 disposed at the outside thereof. The plug 41P and the plug 5 are connected to each other by the power line POL and the communication dedicated line COL. In FIG. 20C, the control input signal of the plug 41P for the PD device (PD) 4 can be switched by the signal conversion circuit 25.

Moreover, the plug 2 connectable to the outlet 1 may be contained in the AC adapter 3 containing the PD device according to the embodiments, as shown in FIGS. 21A to 21C.

As shown in FIG. 21A, the AC adapter/AC charger 3 containing the PD device (PD) 4 according to the embodiments and the plug 2 can be connected to the plug 5 disposed at the outside thereof. The signal conversion circuit 25 and the plug 5 are connected to each other by the power line POL and the communication dedicated line COL. In FIG. 21A, the control input signal of the PD device (PD) 4 can be switched by the signal conversion circuit 25. The signal conversion circuit 25 can be contained in the PD device (PD) 4.

Moreover, the AC adapter/AC charger 3 containing the PD device according to the embodiments and the plug 2 may include the receptacle 41R, as shown in FIG. 21B. In FIG. 21B, the control input signal of the receptacle 41R for the PD device (PD) 4 can be switched by the signal conversion circuit 25.

Moreover, the AC adapter/AC charger 3 containing the PD device according to the embodiments and the plug 2 may include the plug 41P, as shown in FIG. 21C. The plug 41P can be connected to the plug 5 disposed at the outside thereof. The plug 41P and the plug 5 are connected to each other by the power line POL and the communication dedicated line COL. In FIG. 21C, the control input signal of the plug 41P for the PD device (PD) 4 can be switched by the signal conversion circuit 25.

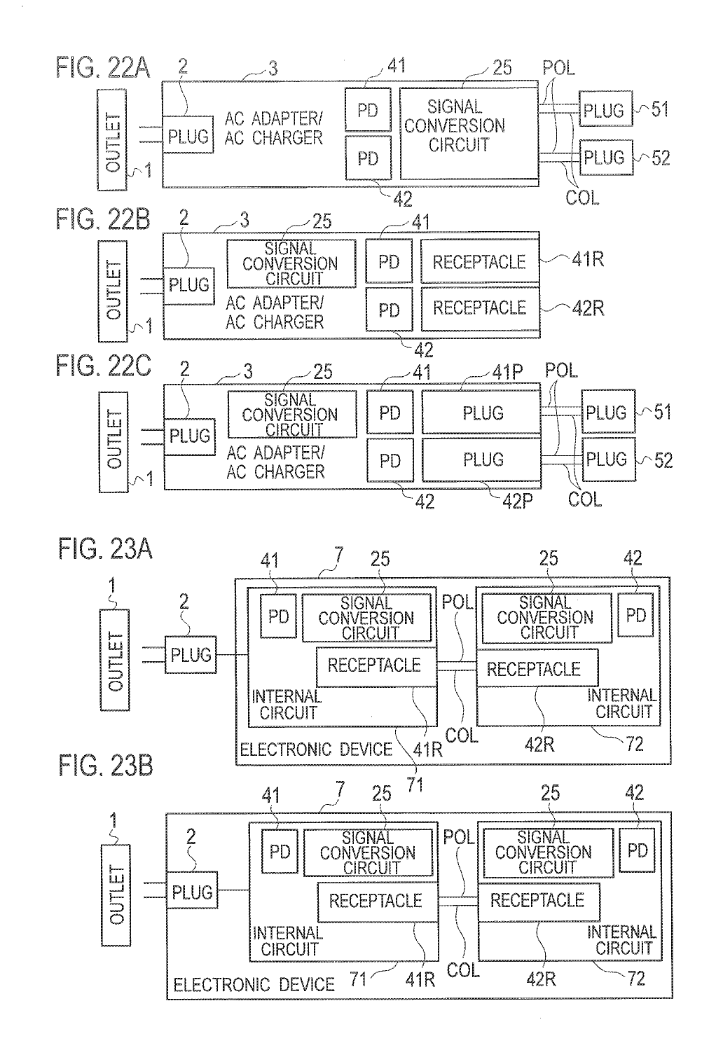

A plurality of the PD devices according to the embodiments can be contained in the AC adapter/AC charger 3, as shown in FIGS. 22A to 22C. Moreover, the plug 2 connectable to the outlet 1 is also contained therein.

As shown in FIG. 22A, the AC adapter/AC charger 3 containing a plurality of the PD devices (PD) 41, 42 according to the embodiments and the plug 2 can be respectively connected to a plurality of the plugs 51, 52 disposed at the outside thereof. The signal conversion circuit 25 and the plugs 51, 52 are connected to each other respectively by the power line POL and the communication dedicated line COL. In FIG. 22A, the control input signals of the PD devices (PD) 41, 42 can be switched by the signal conversion circuit 25. The signal conversion circuit 25 can be contained in the PD devices (PD) 41, 42.

Moreover, the AC adapter/AC charger 3 containing the plurality of the PD devices (PD) 41, 42 according to the embodiments and the plug 2 may include receptacles 41R, 42R, as shown in FIG. 22B. In FIG. 22B, the control input signals of the receptacles 41R, 42R for the plurality of the PD devices (PD) 41, 42 can be switched by the signal conversion circuit 25.

Moreover, the AC adapter/AC charger 3 containing the plurality of the PD devices (PD) 41, 42 according to the embodiments and the plug 2 may include plugs 41P, 42P, as shown in FIG. 22C. The plugs 41P, 42P can be respectively connected to the plugs 51, 52 disposed at the outside thereof. The plugs 41P, 42P and the plugs 51, 52 are respectively connected to each other by the power line POL and the communication dedicated line COL. In FIG. 22C, the control input signals of the plugs 41P, 42P for the PD devices (PD) 41, 42 can be switched by the signal conversion circuit 25.

### (Electronic Apparatus)

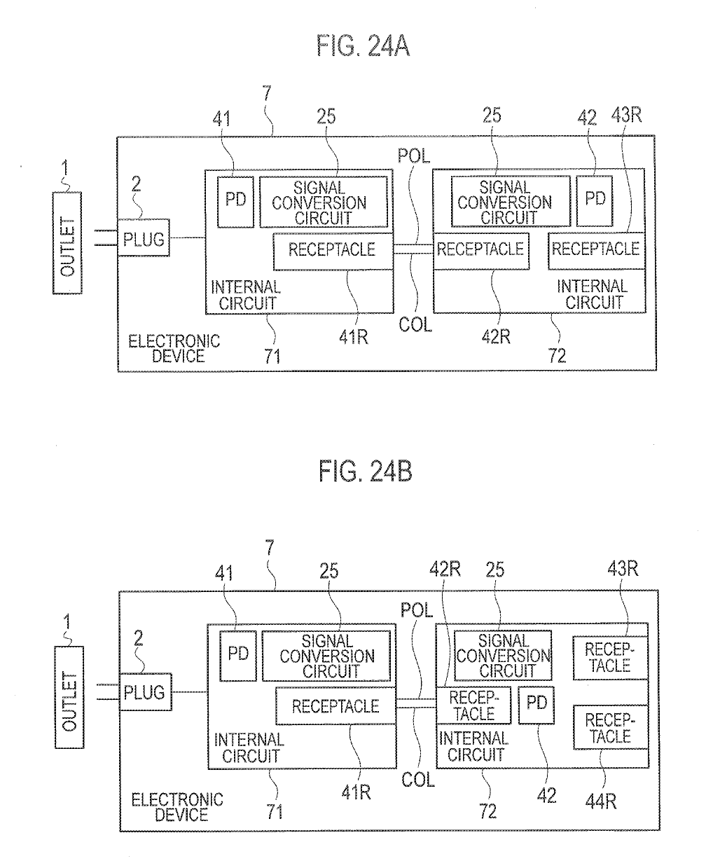

As shown in FIGS. 23 to 24, the PD device according to the first to eighth embodiments can be contained in an electronic apparatus 7. As an electronic apparatus, there are applicable various apparatus, e.g. monitors, external hard disk drives, set top boxes, laptop PCs, tablet PCs, smartphones, battery charger systems, personal computers (PCs), displays, printers, cleaners, refrigerators, facsimiles, telephones, car navigation systems, car computers, television sets, spectacles, head-mounted displays, fans, air-conditioners, laser displays, or wall outlets, for example.

FIG. 23A shows an example of including internal circuits 71, 72 respectively containing the PD devices 41, 42 and the receptacles 41R, 42R in electronic apparatus 7, in an example of wire connection for connecting the electronic apparatus 7 to the plug 2 capable of being connected to the outlet 1 using a cable.

Moreover, FIG. 23B shows an example of containing the plug 2 connectable to the outlet 1 in the electronic apparatus 7, and also including internal circuits 71, 72 respectively containing the PD devices 41, 42 and the receptacles 41R, 42R in the electronic apparatus 7.

In FIGS. 23A and 23B, the receptacles 41R and 42R are connected to each other by the power line POL and the communication dedicated line COL. In FIGS. 23A and 23B, the control input signals of the receptacles 41R, 42R for the PD device (PD) 41, 42 can be switched by the signal conversion circuit 25.

FIG. 24A shows an example of including the receptacle 43R connected to the outside thereof in one internal circuit 72, in an example of containing the plug 2 connectable to the outlet 1 in the electronic apparatus 7, and also including internal circuits 71, 72 respectively containing the PD devices 41, 42 and the receptacles 41R, 42R in the electronic apparatus 7.

Moreover, FIG. 24B shows an example of including a plurality of the receptacles 43R, 44R connected to the outside thereof in one internal circuit 72, in an example of containing the plug 2 connectable to the outlet 1 in the electronic apparatus 7, and also including internal circuits 71, 72 respectively containing the PD devices 41, 42 and the receptacles 41R, 42R in the electronic apparatus 7.

Also in FIGS. 24A and 24B, the receptacles 41R and 42R can be connected to each other by the power line POL and the communication dedicated line COL. Moreover, in FIGS. 24A and 24B, the control input signals of the receptacles 41R, 42R for the PD devices (PD) 41, 42 can be switched by the signal conversion circuit 25.

### (Protection Function)

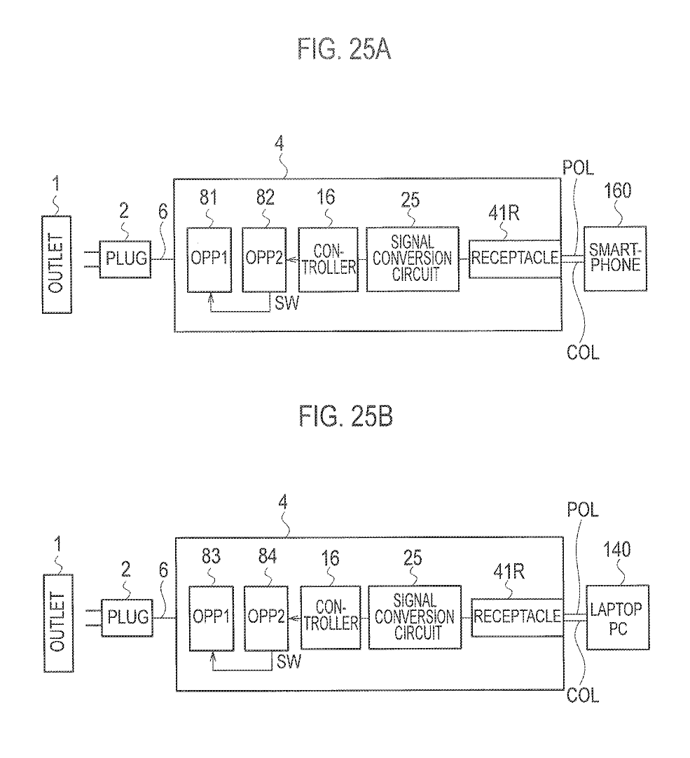

FIG. 25A shows an explanatory diagram of a protection function for the PD device 4 according to the embodiments in a case of using a smartphone 160 as a connecting target, and FIG. 25B shows an explanatory diagram of the protection function for the PD device 4 according to the embodiments in a case of using a laptop PC 140 as a connecting target.

As shown in FIGS. 25A and 25B, the PD device 4 according to the embodiments may include: a primary-side overpower protecting circuit (OPP1) (81, 83); and a secondary-side overpower protecting circuit (OPP2) (82, 84) connected to the primary-side overpower protecting circuit (OPP1) (81, 83). The primary-side overpower protecting circuit (OPP1) (81, 83) is connected to a primary-side controller (not shown). Moreover, the primary-side overpower protecting circuit (OPP1) (81, 83) may be contained in the primary-side controller. The secondary-side overpower protecting circuit (OPP2) (82, 84) is connected to the secondary-side controller 16.

Moreover, as shown in FIGS. 25A and 25B, the receptacle 41R and the connecting target (e.g., the smartphone 160 and the laptop PC 140) are connected to each other by the power line POL and the communication dedicated line COL. The signal conversion circuit 25 is connected between the secondary-side controller 16 and the receptacle 41R, and the control input signal of the receptacle 41R for the PD device (PD) (41, 42) can be switched by the signal conversion circuit 25.

In accordance with target equipment (target sets) connected to the receptacle 41R, electric power information and communication control information in the receptacle 41R are transmitted to the secondary-side overpower protecting circuit (OPP2) (82, 84) from the secondary-side controller 16, and then the secondary-side overpower protecting circuit (OPP2) (82, 84) transmits the aforementioned electric power information and communication control information to the primary-side overpower protecting circuit (OPP1) (81, 83). Consequently, an overcurrent detecting set value can be changed in accordance with the target equipment (target sets) connected to the receptacle 41R, thereby executing power change of the DC/DC converter 13.

Any of the primary-side overpower protecting circuit (OPP1) 81 and the secondary-side overpower protecting circuit (OPP2) 82 may determine whether the electric power information and communication control information in the receptacle 41R exceeds the overcurrent detecting set value.

If it is determined that the electric power information and communication control information in the receptacle 41R exceed the overcurrent (overpower) detecting set value, the primary-side overpower protecting circuit (OPP1) (81, 83) transmits an overcurrent (overpower) protecting control signal to the primary-side controller (not shown), thereby executing the change for controlling the electric power in the DC/DC converter 13.

Various functions, e.g. Over Current Protection (OCP), Over Power Protection (OPP), Over Voltage Protection (OVP), Over Load Protection (OLP), and Thermal Shut Down (TSD), are applicable to the PD device 4 according to the embodiments.

The PD device 4 according to the embodiments includes a sensor (SENSOR) protection function for executing protection corresponding to the characteristics of a certain sensor element connected to the primary-side controller (not shown), for example.

When the overcurrent (overpower) detecting set value is changed in the PD device 4 according to the embodiments, the electric power information and communication control information in the receptacle 41R are transmitted to the primary-side overpower protecting circuit (OPP1) (81, 83) through the secondary-side controller 16 and the secondary-side overpower protecting circuit (OPP2) (82, 84), as mentioned above. Consequently, an overcurrent detecting set value can be changed in accordance with the target equipment (target sets) connected to the receptacle 41R, thereby executing power change of the DC/DC converter 13.

Moreover, when the overcurrent (overpower) detecting set value is changed in the PD device 4 according to the embodiments, the electric power information and communication control information in the receptacle 41R may be directly transmitted to the primary-side overpower protecting circuit (OPP1) (81, 83) from the secondary-side controller 16, thereby directly changing the set value in the primary-side overpower protecting circuit (OPP1) (81, 83).

Moreover, the electric power information may be directly transmitted to the primary-side overpower protecting circuit (OPP1) (81, 83) from the outside of the PD device 4A according to the embodiments.

Thus, according to the PD device 4 according to the embodiments, it is possible to change the PD level in accordance with the target equipment (target sets) connected to the receptacle 41R, in the primary-side overpower protecting circuit (OPP1) (81, 83). Consequently, a destruction of the target equipment (target sets) can be prevented under an abnormal state.

When using a smart phone 160 as a connecting target, with respect to the smart phone 160 (the amount of power 5V·1 A=5 W), if the electric power information and communication control information of 7 W is transmitted to the secondary-side overpower protecting circuit (OPP2) 82 from the secondary-side controller 16, for example, the electric power information and communication control information of 7 W is transmitted to the primary-side overpower protecting circuit (OPP1) 81 from the secondary-side overpower protecting circuit (OPP2) 82, and then the overcurrent (overpower) detecting set value is changed (SW) from 7 W up to 10 W in the primary-side overpower protecting circuit (OPP1) 81. Consequently, the electric power up to 10 W can be transmitted, in the DC/DC converter in the PD device 4 according to the embodiments.

When using a laptop PC 140 as a connecting target, with respect to the laptop PC 140 (the amount of power 20V˜3 A=60 W), if the electric power information and communication control information of 80 W is transmitted to the secondary-side overpower protecting circuit (OPP2) 84 from the secondary-side controller 16, for example, the electric power information and communication control information of 80 W is transmitted to the primary-side overpower protecting circuit (OPP1) 83 from the secondary-side overpower protecting circuit (OPP2) 84, and then the overcurrent (overpower) detecting set value is changed (SW) from 80 W up to 100 W in the primary-side overpower protecting circuit (OPP1) 83. Consequently, the electric power up to 100 W can be transmitted, in the DC/DC converter in the PD device 4 according to the embodiments.

### (Receptacle/Plug)

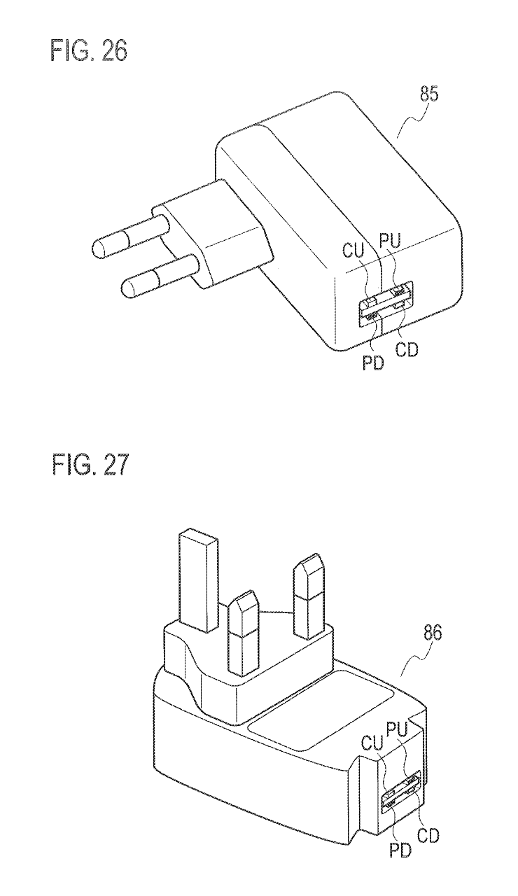

As shown in FIG. 26, the PD device 85 according to the embodiments applicable to the AC adapter, the AC charger, and the electronic apparatus in which the receptacle is mounted can be connected an outlet having AC power sources 100V-115V, and a plug connected to the power line POL and the communication dedicated line COL can be inserted thereinto. An example of plug structure is shown in FIG. 29.

The power line POL can be connected to any of an upper-side power terminal PU and a lower-side power terminal PD of the receptacle, and the communication dedicated line COL can be connected to any of an upper-side communication terminal CU and a lower-side communication terminal CD of the receptacle. The electric power information can be transmitted through the power line POL, and the communication control information can be transmitted through the communication dedicated line COL. As shown in FIG. 26, The receptacle 85 applicable to the AC adapter, the AC charger, and the electronic apparatus in which the PD device according to the embodiments is mounted can be connected to any of the power terminals PU, PD and the communication terminals CU, CD, and there is no need to select the upper or lower side (front or back two surfaces) of the corresponding plug, and therefore convenience in use is effective.

Moreover, as shown in FIG. 27, the PD device 86 according to the embodiments applicable to the AC adapter, the AC charger, and the electronic apparatus in which the receptacle is mounted can be connected an outlet having AC power sources 230V, and a plug connected to the power line POL and the communication dedicated line COL can be inserted thereinto. An example of plug structure is shown in FIG. 29.

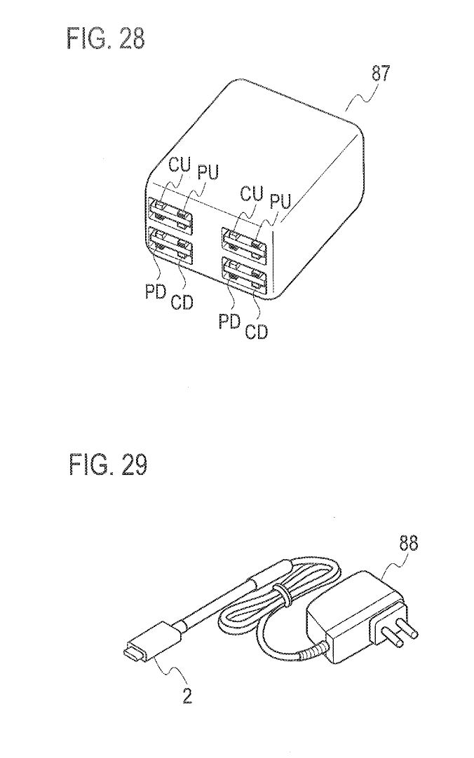

Moreover, as shown in FIG. 28, the PD device 87 according to the embodiments applicable to the AC adapter, the AC charger, and the electronic apparatus in which the receptacle is mounted can be connected an outlet having AC power sources 100V-115V, and a plurality of plugs connected to the power line POL and the communication dedicated line COL can be inserted thereinto. An example of plug structure is shown in FIG. 29.

One or a plurality of signal conversion circuits can be contained in the AC adapter, the AC charger, and the electronic apparatus. By such a signal conversion circuit operation, the number of extraction of the outputs of the receptacles 85, 86, 87 can be variously selected. For example, it is possible to set a ratio of the number of extraction as 1:N, 1:1, or N:1, where N is an integer greater than or equal to 2. Moreover, it is also possible to use in conjunction with the USB PD receptacle.

Moreover, as shown in FIG. 29, the PD device 88 according to the embodiments applicable to the AC adapter, the AC charger, and the electronic apparatus in which the plug 2 is mounted can be connected an outlet having AC power sources 100V-115V, and an outlet having AC power sources 230V. The plug 2 is synonymous with configurations shown in FIGS. 17A and 17B, 18B, 19A and 19C, 20A and 20C, 21A and 21C, and 22A and 22C. Moreover, the plug 2 may be applicable also to the USB PD. Accordingly, in FIG. 29, the plug 2 can be called as an advanced USB plug.

A plug for an ordinary USB has VBUS, D+, D−, and GND terminals having an electrode at one side thereof. A plug for the USB PD has VBUS, D+, D−, and GND terminals having an electrode at one side thereof (its shape is the same as that of USB.).

In the embodiments, the above-mentioned advanced USB plug 2 has VBUS, D+, D−, CU or CD, and GND terminals having electrodes in both sides and do not have difference in the back and front. The CU or CD terminal is connected to the communication dedicated line COL used for two-way communications between apparatuses. The advanced USB plug 2 is inserted in the advanced USB receptacle in order to realize the power supply and data communications. Accordingly, the plug 2 can be called as an advanced USB plug, and the receptacle can be called as an advanced USB receptacle.

### (A Plurality of Connecting Targets)

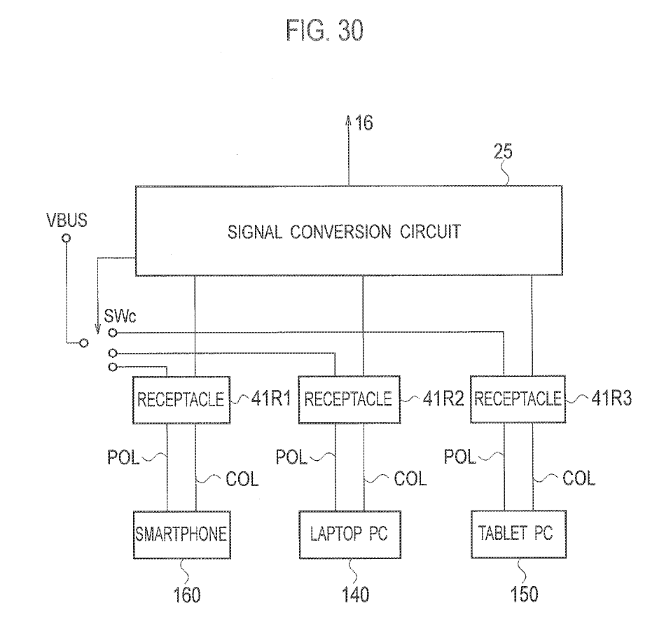

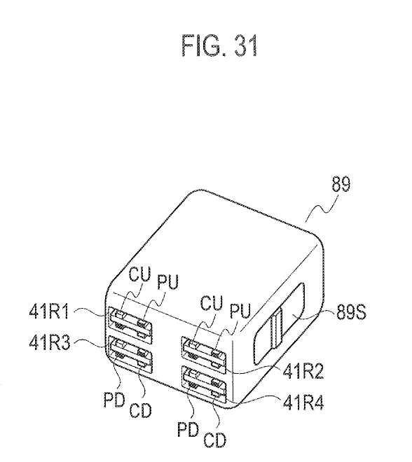

FIG. 30 shows a schematic circuit block configuration of the PD device according to the embodiments connected to a plurality of connecting targets through a plurality of the receptacles. In FIG. 30, the signal conversion circuit 25 connected with a secondary-side controller (not shown) is connected to a smartphone 160, a laptop PC 140, and a tablet PC 150 which are connecting targets respectively through the receptacles 41R1, 41R2, 41R3. The signal conversion circuit 25 and the connecting targets may be connected to each other through the coupling capacitor CC and the AC coupling capacitors Ct1, Ct2, Ct3. The power line POL and the communication dedicated line COL are connected to between the receptacles 41R1, 41R2, 41R3 and the smartphone 160, the laptop PC 140, and the tablet PC 150. The power line POL is controlled to be switched by a switch SWC controllable by the signal conversion circuit 25, and is connected to the power line output (VBUS). A control input signal from the smartphone 160, the laptop PC 140, and the tablet PC 150 to the PD device 4, and a control output signal from the PD device according to the embodiments to the smartphone 160, the laptop PC 140, and the tablet PC 150 can be transmitted on the communication dedicated line COL.

FIG. 31 shows a schematic bird's-eye view structure example of the PD device 89 according to the embodiments applicable to the AC adapter, the AC charger, and the electronic apparatus in which a plurality of receptacles 41R1, 41R2, 41R3, 41R4 are mounted. In an example of FIG. 31, four receptacles 41R1, 41R2, 41R3, 41R4 can be connected thereto, and can be manually switched by a switch 89S. The receptacles 41R1, 41R2, 41R3 shown in FIG. 30 respectively correspond to the receptacles 41R1, 41R2, 41R3 shown in FIG. 31. Moreover, although the example of providing four pieces of the receptacles 41R1, 41R2, 41R3, 41R4 is shown in FIG. 31, it is also adaptable to an arbitrary number of pieces, e.g. two pieces, or six pieces, of the receptacles.

### (USB PD Communications)

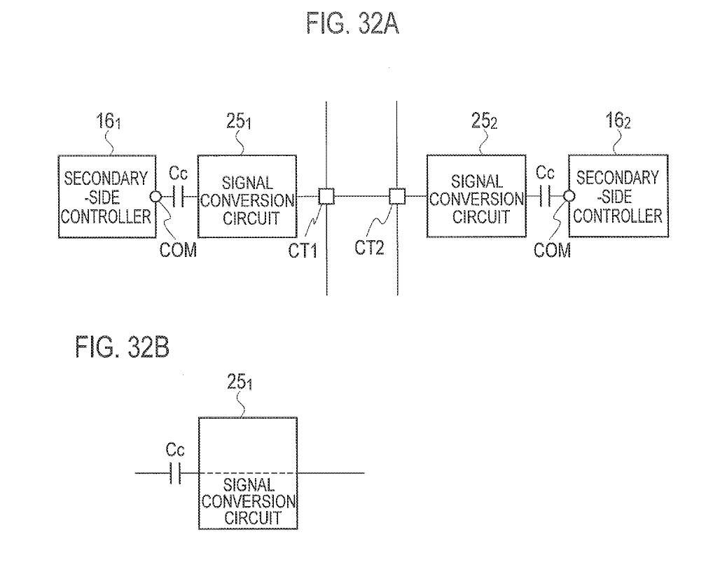

FIG. 32A shows a schematic circuit block configuration for explaining an example of using control input output signals for a USB PD communications between a plurality of the PD devices according to the embodiments. FIG. 32B shows a schematic circuit block configuration showing a case where the control input output signal passes through in the inside of the signal conversion circuit, in FIG. 32A.

In the first PD device, as shown in FIG. 32A, the secondary-side controller 161 is connected to the signal conversion circuit 251 through the coupling capacitor CC, and the signal conversion circuit 251 is connected to the control terminal CT1. Illustration of other configurations are omitted. In the second PD device, as shown in FIG. 32A, the secondary-side controller 162 is connected to the signal conversion circuit 252 through the coupling capacitor CC, and the signal conversion circuit 252 is connected to the control terminal CT2. Illustration of other configurations are omitted. In addition, the signal conversion circuits 251, 252 may be respectively connected to the control terminals CT1, CT2 through the AC coupling capacitors Ct.

In the USB PD communications, the control terminals CT1, CT2 are connected to each other by the power line POL.

When the control input output signal is used for the USB PD communications between the first PD device and the second PD device, it may be configured so that the control input output signal may pass through in the inside of the signal conversion circuit 251, as shown in FIG. 32B.

### (PD System)

In the PD system to which the PD device according to the embodiments can be applied, a source of electric power can be switched without changing a direction of the cable. For example, electric charging of a battery in a laptop PC from external devices and power transmission from a battery or an internal PD device in the laptop PC to external devices (e.g., display etc.) can be achieved without replacement of the cable.

Moreover, power transmission and half-duplex data communications can be realized between two units through the power line POL and the communication dedicated line COL.

In the PD system to which the PD device according to the embodiments can be applied, DC Power Delivery (DC PD) (DC output VBUS) and data communications can be transmitted between the battery charger system and the laptop PC by using the power line POL and the communication dedicated line COL. In this case, the PD device according to the embodiments is mounted in the battery charger system and the laptop PC.

In the PD system to which the PD device according to the embodiments can be applied, the DC PD (DC output VBUS) and the data communications can be transmitted by using the power line POL and the communication dedicated line COL, between the smartphone and the laptop PC. In this case, the PD device according to the embodiments is mounted in the smartphone and the laptop PC.

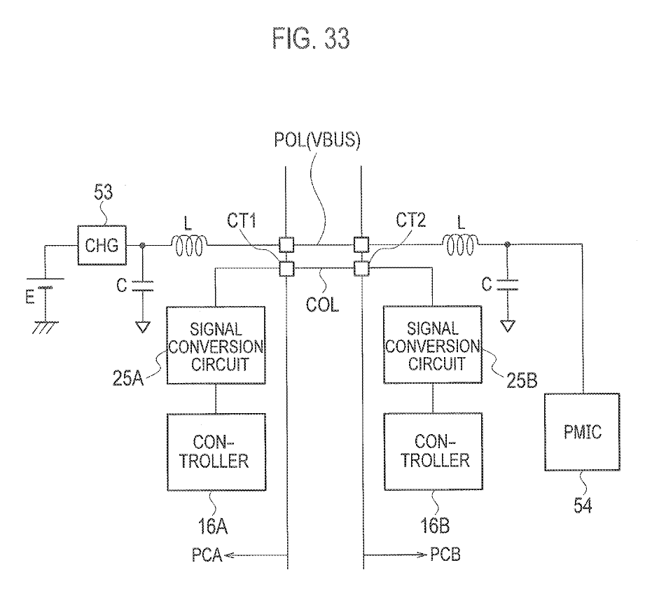

FIG. 33 shows a schematic block configuration for explaining the data communications and the electric power supply between two personal computers (PCs) PCA, PCB, in the PD system to which the PD device according to the embodiments can be applied. In FIG. 33, illustration of the DC/DC converters are omitted, but the secondary-side controllers 16A, 16B, and the signal conversion circuits 25A, 25B are shown. The PD devices according to the embodiments are respectively mounted in the personal computers (PCs) PCA, PCB. In addition, the secondary-side controllers 16A, 16B and the signal conversion circuits 25A, 25B are respectively and directly connected to each other. Moreover, the secondary-side controllers 16A, 16B and the signal conversion circuits 25A, 25B may be respectively connected to each other through the coupling capacitors CC.

The personal computers (PC) PCA, PCB are connected to each other through the power line POL and the communication dedicated line COL. The communication dedicated line COL is connected between the control terminals CT1, CT2.

As shown in FIG. 33, the control terminal CT1 is connected to the controller 16A through the signal conversion circuit 25A, and the control terminal CT2 is connected to the controller 16B through the signal conversion circuit 25B. Moreover, the signal conversion circuits 25A, 25B, and the control terminals CT1, CT2 may be respectively connected to each other through the AC coupling capacitors Ct. Moreover, a battery E and a battery charger IC (CHG) 53 connected to the battery E is mounted in the personal computer (PC) PCA, and a Power Management IC (PMIC) 54 is mounted in the personal computer (PC) PCB. In addition, the inductances LF, CF configuring the filter circuit can be respectively omitted.

In the PD system to which the PD device according to the embodiments can be applied, electric charging of the battery E from the personal computer PCB to the personal computer PCA, and power transmission of the battery E from the personal computer PCA to the personal computer PCB can achieved without replacement of any cable, for example.

Moreover, the secondary-side controllers 16A, 16B are respectively connected to the communication dedicated lines COL through the signal conversion circuits 25A, 25B, and thereby realizing half-duplex data communications between the personal computers (PCs) PCA, PCB. In the present embodiments, the carrier frequency is approximately 23.2 MHz, for example, and the FSK modulation/demodulation frequency is approximately 300 kbps, for example. In the present embodiments, the Bit Error Rate (BER) is approximately 1×10-6, and an LSI for built-in self tests (BIST) may be included therein, for example.

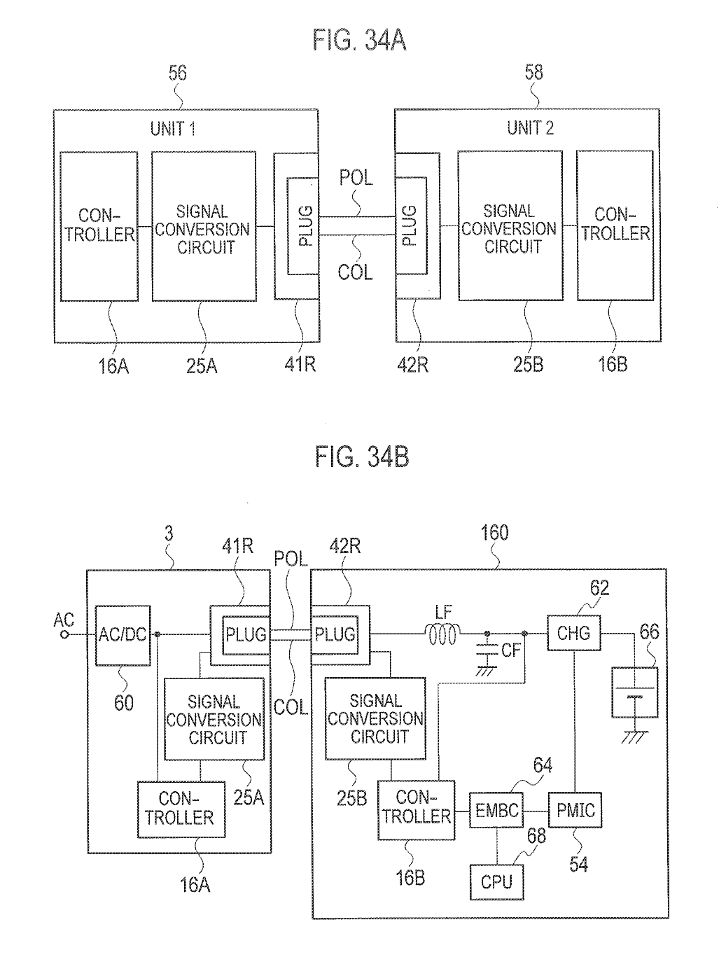

FIG. 34A shows a schematic block configuration for explaining the data communications and the electric power supply between two units 56, 58, in the PD system to which the PD device according to the embodiments can be applied.

The two units 56, 58 are connected to each other by the power line POL and the communication dedicated line COL. The power line POL and the communication dedicated line COL is plug-connected to the receptacles 41R, 42R contained in the two units 56, 58.

The two units 56, 58 are arbitrary electronic apparatuses in which the PD devices according to the embodiments are respectively mounted. In FIG. 34A, illustration of the DC/DC converters are omitted, but the secondary-side controllers 16A, 16B, and the signal conversion circuits 25A, 25B are shown. Illustration of the AC coupling capacitor Ct is also omitted. Moreover, the secondary-side controllers 16A, 16B and the signal conversion circuits 25A, 25B are respectively and directly connected to each other. Moreover, the secondary-side controllers 16A, 16B and the signal conversion circuits 25A, 25B may be respectively connected to each other through the coupling capacitors CC.

FIG. 34B shows a schematic block configuration of a PD system including an AC adapter/AC charger 3 and a smartphone 160 each which contains the PD device according to the embodiments.

The AC adapter/AC charger 3 and the smartphone 160 are connected to each other by the power line POL and the communication dedicated line COL. The power line POL and the communication dedicated line COL are plug-connected to the receptacles 41R, 42R respectively contained in the AC adapter 3 and the smartphone 160.

The PD devices according to the embodiments are respectively mounted in the AC adapter/AC charger 3 and the smartphone 160. In FIG. 34B, illustration of the DC/DC converters is omitted, but the secondary-side controllers 16A, 16B and the signal conversion circuits 25A, 25B are shown.

The AC adapter/AC charger 3 includes the AC/DC converter 60, the secondary-side controller 16A, and the signal conversion circuit 25A. The smartphone 160 includes the secondary-side controller 16B, the signal conversion circuit 25B, an embedded type controller (EMBC) 64, a CPU 68, a PMIC 54, a battery 66, and a battery charger IC (CHG) 62. The coupling capacitors CC may be respectively provided between the secondary-side controllers 16A, 16B and the signal conversion circuits 25A, 25B. Moreover, the AC coupling capacitors Ct may be respectively provided between the signal conversion circuits 25A, 25B and the receptacles 41R, 42R. In addition, the inductances LF, CF configuring the filter circuit can be respectively omitted.

In the PD system to which the PD device according to the embodiments can be applied, electric charging of the battery 66 in the smart phone 160 from the AC adapter/AC charger 3, and power transmission to the external device from the battery 66 in the smart phone 160 can be achieved without replacement of the cable, for example.

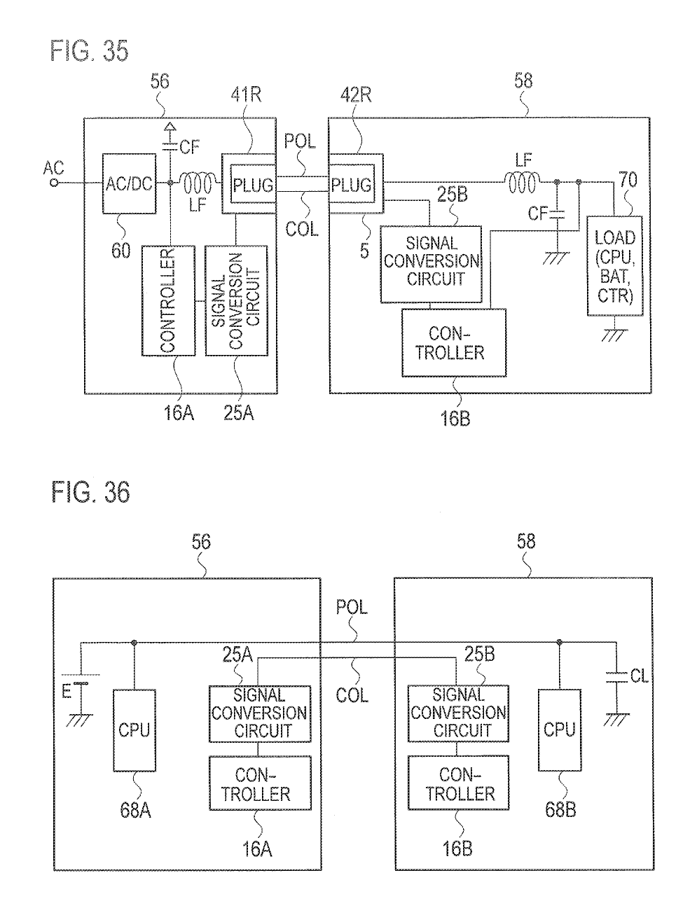

FIG. 35 shows a schematic block configuration of a PD system including two units 56, 58 each containing the PD device according to the embodiments.

The two units 56, 58 are connected to each other by the power line POL and the communication dedicated line COL. The power line POL and the communication dedicated line COL is plug-connected to the receptacles 41R, 42R contained in the two units 56, 58.

The PD devices according to the embodiments are respectively mounted in the two units 56, 58. In FIG. 35, illustration of the DC/DC converters are omitted, but the secondary-side controllers 16A, 16B, and the signal conversion circuits 25A, 25B are shown.

The unit 56 includes the AC/DC converter 60, the secondary-side controller 16A, and the signal conversion circuit 25A, and the unit 58 includes the secondary-side controller 16B, the signal conversion circuit 25B, and a load 70. In the present embodiment, the load 70 can be composed of a CPU, a battery BAT, a controller CTR, etc. The coupling capacitors CC may be respectively provided between the secondary-side controllers 16A, 16B and the signal conversion circuits 25A, 25B. Moreover, the AC coupling capacitors Ct may be respectively provided between the signal conversion circuits 25A, 25B and the receptacles 41R, 42R. In addition, the inductances LF, CF configuring the filter circuit can be respectively omitted.

In the PD system to which the PD device according to the embodiments can be applied, power transmission from the unit 56 to the unit 58, and power transmission to external devices from the unit 58 can be achieved without replacement of the cable, for example.

Moreover, the secondary-side controllers 16A, 16B are respectively connected to the communication dedicated lines COL through the AC coupling capacitor CC and the signal conversion circuits 25A, 25B, thereby realizing half-duplex data communications between the units 56, 58.

In the PD system to which the PD device according to the embodiments can be applied, FIG. 36 shows a schematic block configuration composed of two units 56, 58 different from the configuration shown in FIG. 35.

The unit 56 includes a battery E, a CPU 68A, the secondary-side controller 16A, and the signal conversion circuit 25A, and the unit 58 includes a CPU 68B, the secondary-side controller 16B, the signal conversion circuit 25B, and a load CL.

The two units 56, 58 are connected to each other by the power line POL and the communication dedicated line COL. The power line POL and the communication dedicated line COL is plug-connected to the receptacles 41R, 42R (not shown) contained in the two units 56, 58. The power line POL is connected between the battery E and the load CL, and the communication dedicated line COL is connected between the secondary-side controllers 16A, 16B. The coupling capacitors CC may be respectively provided between the secondary-side controllers 16A, 16B and the signal conversion circuits 25A, 25B. Moreover, the AC coupling capacitors Ct may be respectively provided between the signal conversion circuits 25A, 25B and the communication dedicated line COL.

In the PD system to which the PD device according to the embodiments can be applied, power transmission from the unit 58 to the unit 56, and power transmission to the unit 58 from the battery E can be achieved without replacement of the cable, for example. Moreover, the half-duplex data communications, for example, can be realized between the units 56, 58.

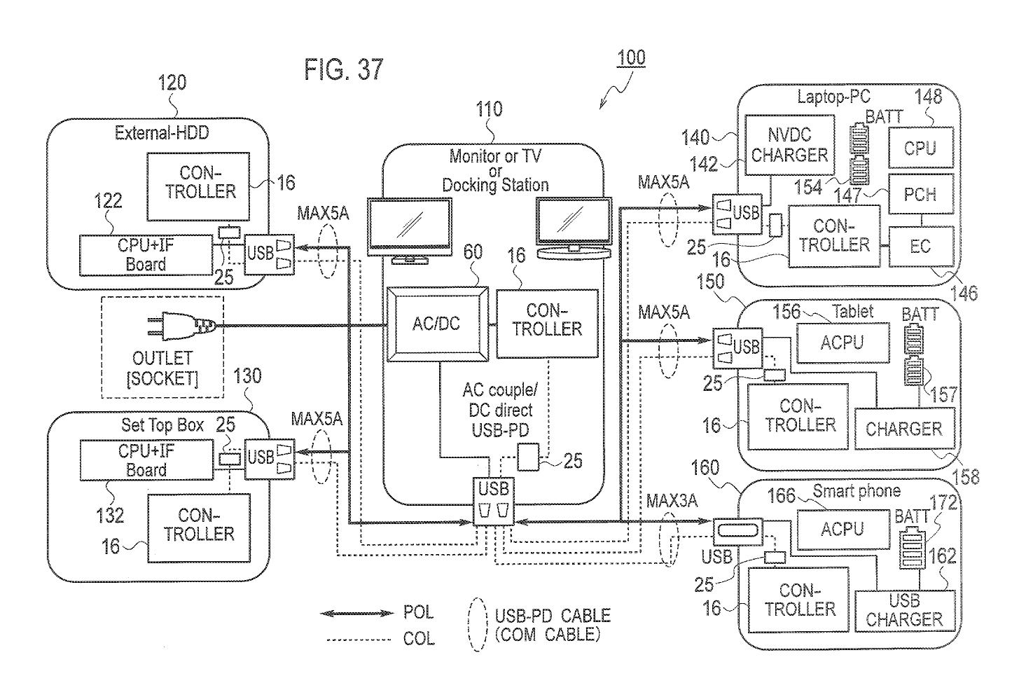

As shown in FIG. 37, a first PD system 100 to which the PD device according to the embodiments can be globally applied includes: a monitor 110 connected to an outlet through a plug; and an external hard disk drive 120, a set top box 130, a laptop PC 140, a tablet PC 150, and a smart phone 160 each connected to the monitor 110 using the USB PD cable. In the present embodiment, otherwise, the monitors 110 may be TV or a docking station.

Although the PD device 4 according to the embodiments is mounted in each configuring element, illustration of the DC/DC converter and the coupling capacitor CC is omitted, but the controller 16 and the signal conversion circuit 25 are shown in FIG. 37. Moreover, the AC coupling capacitor Ct may be applied to the communication dedicated line COL. Moreover, when applying the USB PD, a USB PD controller may be applied to the controller 16.

Power transmission and communications data transmission can be executed using the power line POL and the communication dedicated line COL, between the monitor 110, and the external hard disk drive 120, the set top box 130, the laptop PC 140, the tablet PC 150 and the smartphone 160. The power line POL is illustrated with the thick solid line, and the communication dedicated line COL is illustrated with the dashed line. When applying the USB PD, the power line POL may be used therefor, instead of the communication dedicated line COL illustrated with the dashed line. Moreover, the communication dedicated line COL is connected to the signal conversion circuit 25 and the controller 16 through the AC coupling capacitor Ct (not shown). Alternatively, the communication dedicated line COL may be directly connected to the signal conversion circuit 25 and the controller 16, without through the AC coupling capacitor Ct.

Portions illustrated with the circular dashed-line illustrate that the cable used for the power line POL and the cable used for communication dedicated line COL are separated. A USB PD cable can be applied to the cable for the power line POL, and a communication dedicated cable (COM) can be applied to the cable for the communication dedicated line COL. Moreover, an internal cable for changing between the power line POL and the communication dedicated line COL may be used therefor.

The AC/DC converter 60, the controller 16, and the signal conversion circuit 25 are mounted in the monitor 110. A CPU+interface board 122, the controller 16, and the signal conversion circuit 25 are mounted in the external hard disk drive 120. A CPU+interface board 132, the controller 16, and the signal conversion circuit 25 are mounted in the set top box 130. A Narrow Voltage DC/DC (NVDC) charger 142, a CPU 148, a Platform Controller Hub (PCH) 147, an Embedded Controller (EC) 146, the controller 16, and the signal conversion circuit 25 are mounted in the laptop PC 140. An Application CPU (ACPU) 156, a battery charger IC (CHG) 158, a battery 157, the controller 16, and the signal conversion circuit 25 are mounted in the tablet PC 150. An Application CPU (ACPU) 166, a USB charger 162, a battery 172, the controller 16, and the signal conversion circuit 25 are mounted in a smartphone 160.

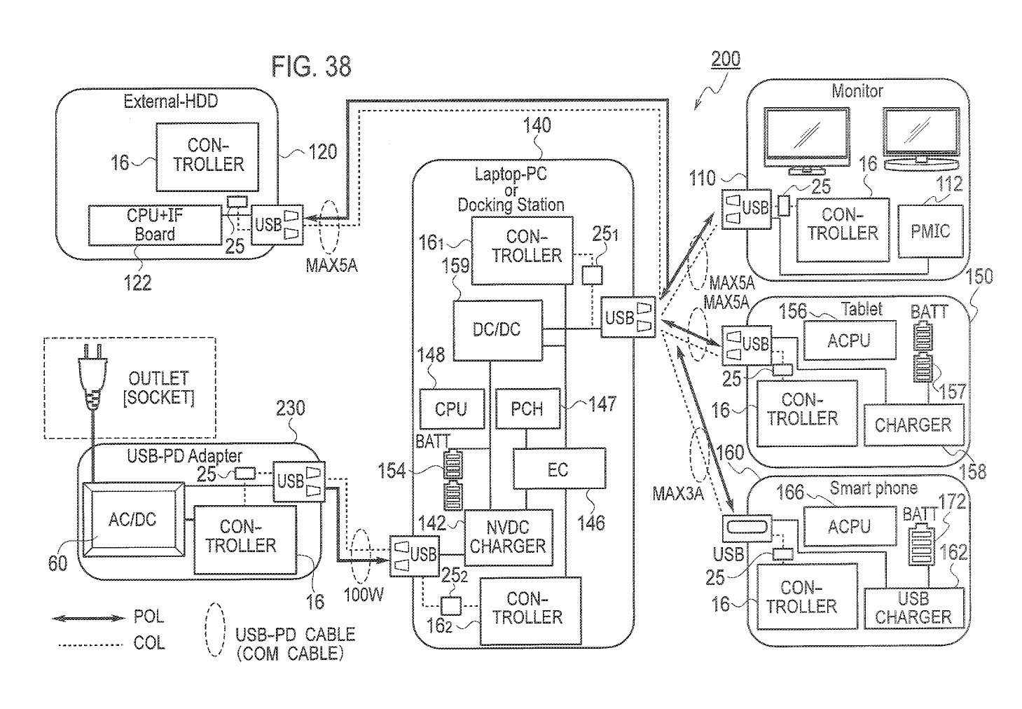

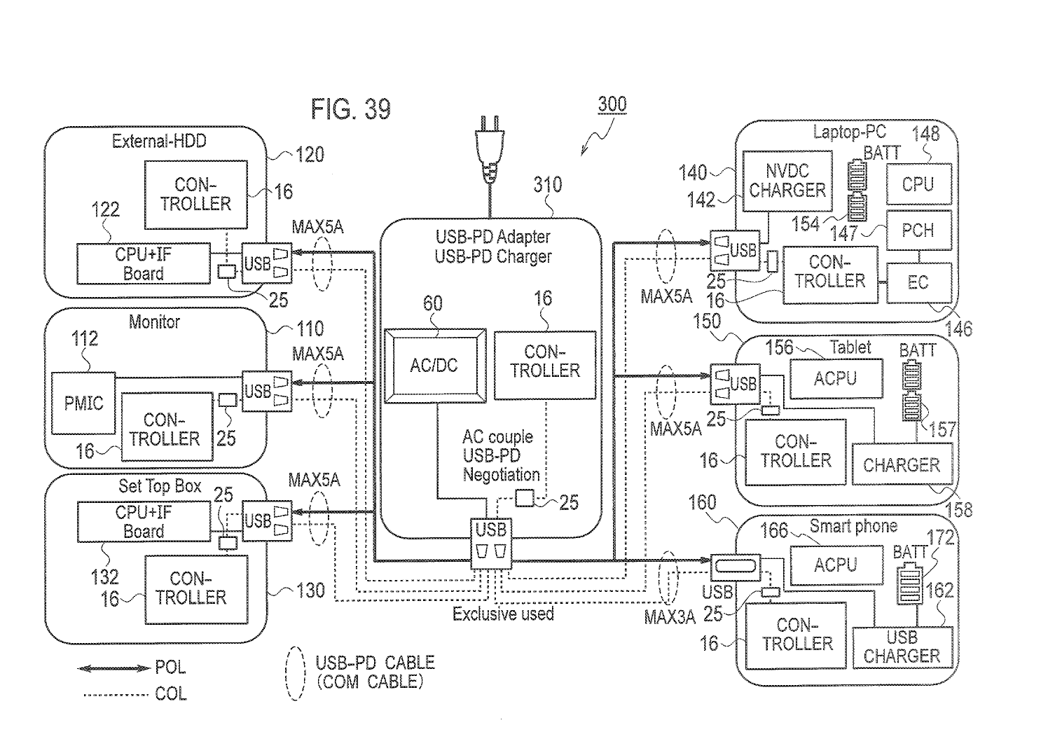

As shown in FIG. 38, a second PD system 200 to which the PD device according to the embodiments can be globally applied includes: a USB PD adapter 230 connected to an outlet through a plug; a laptop PC 140 connected to the USB PD adapter 230; and an external hard disk drive 120, a monitor 110, a tablet PC 150, and a smartphone 160 connected to the laptop PC 140. In the present embodiments, otherwise, the laptop PC 140 may be a docking station.

Although the PD device 4 according to the embodiments is mounted in each configuring elements, illustration of the DC/DC converter and the coupling capacitor CC is omitted, but the controller 16 and the signal conversion circuit 25 are illustrated in FIG. 38. Moreover, the AC coupling capacitor Ct may be applied to the communication dedicated line COL. Moreover, when applying the USB PD, a USB PD controller may be applied to the controller 16.

Power transmission and communications data transmission can be executed using the power line POL and the communication dedicated line COL, between the laptop PC 140, and the USB PD adapter 230, the external hard disk drive 120, the monitor 110, the tablet PC 150 and the smartphone 160.

The AC/DC converter 60, the controller 16, and the signal conversion circuit 25 are mounted in the USB PD adapter 230. The NVDC charger 142, the CPU 148, the PCH 147, the EC 146, the battery 154, the DC/DC converter 159, the controllers 161, 162, and the signal conversion circuits 251, 252 are mounted in the laptop PC 140. The PMIC 112, the controller 16, and the signal conversion circuit 25 are mounted in the monitor 110. Other configurations are the same as those of the first PD system 100 (FIG. 37).

As shown in FIG. 39, a third PD system 300 to which the PD device according to the embodiments can be globally applied includes: a USB PD adapter/charger 310 connected to an outlet through a plug; and an external hard disk drive 120, a monitor 110, a set top box 130, a laptop PC 140, a tablet PC 150, and a smart phone 160 each connected to the USB PD adapter/charger 310.

Although the PD device 4 according to the embodiments is mounted in each configuring elements, illustration of the DC/DC converter and the coupling capacitor CC is omitted, but the controller 16 and the signal conversion circuit 25 are illustrated in FIG. 39. Moreover, the AC coupling capacitor Ct may be applied to the communication dedicated line COL. Moreover, when applying the USB PD, a USB PD controller may be applied to the controller 16.

Power transmission and communications data transmission can be executed using the power line POL and the communication dedicated line COL, between the USB PD adapter/charger 310, and the external hard disk drive 120, the monitor 110, the set top box 130, the laptop PC 140, the tablet PC 150 and the smartphone 160.

The AC/DC converter 60, the controller 16, and the signal conversion circuit 25 are mounted in the USB PD adapter/charger 310. Other configurations are the same as those of the first PD system 100 (FIG. 37) and the second PD system 200 (FIG. 38).

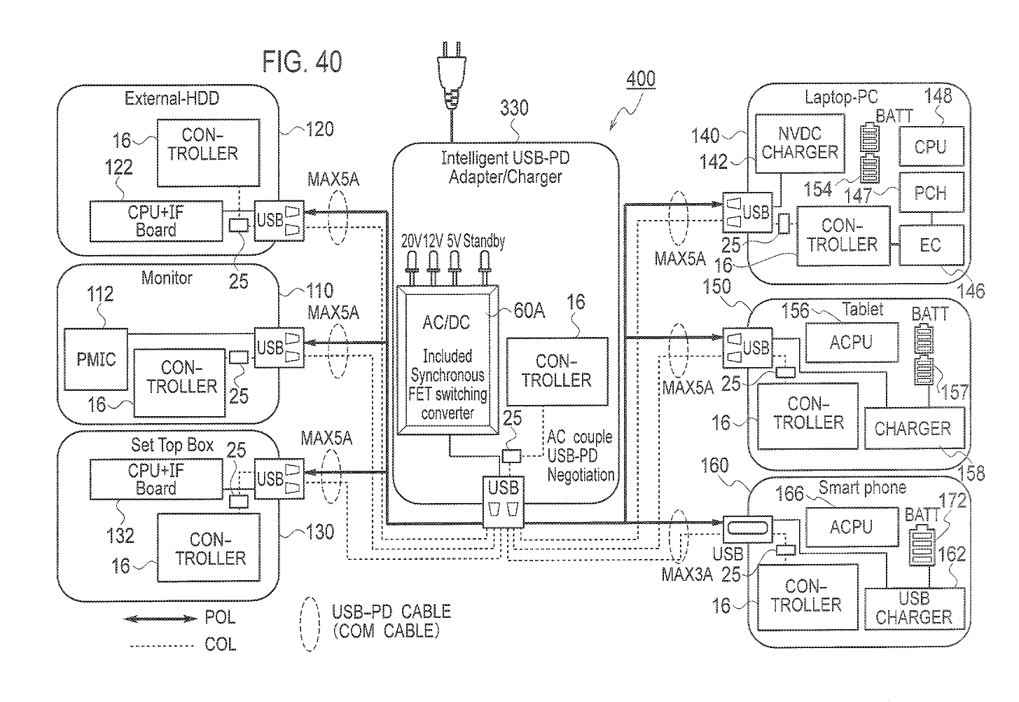

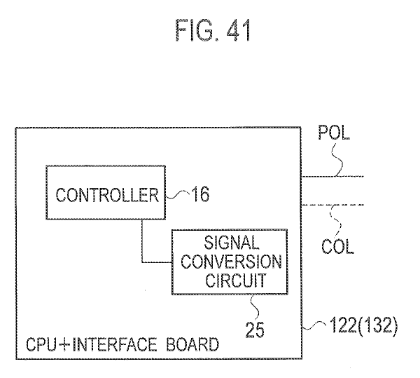

As shown in FIG. 40, a fourth PD system 400 to which the PD device according to the embodiments can be globally applied includes: a high-performance USB PD adapter/charger 330 connected to an outlet through a plug; and An external hard disk drive 120, a monitor 110, a set top box 130, a laptop PC 140, a tablet PC 150, and a smart phone 160 each connected to the high-performance USB PD adapter/charger 330.

Although the PD device 4 according to the embodiments is mounted in each configuring elements, illustration of the DC/DC converter and the coupling capacitor CC is omitted, but the controller 16 and the signal conversion circuit 25 are illustrated in FIG. 40. Moreover, the AC coupling capacitor Ct may be applied to the communication dedicated line COL. Moreover, when applying the USB PD, a USB PD controller may be applied to the controller 16.

Power transmission and communications data transmission can be executed using the power line POL and the communication dedicated line COL, between the high-performance USB PD adapter/charger 330, and the external hard disk drive 120, the monitor 110, the set top box 130, the laptop PC 140, the tablet PC 150 and the smartphone 160.

The AC/DC converter 60A including a synchronous FET switching converter, the controller 16, and the signal conversion circuit 25 are mounted in the high-performance USB PD adapter/charger 330. Other configurations are the same as those of the third PD system 300 (FIG. 39).

FIG. 41 shows a schematic block configuration having a configuration in which the controller 16 is contained in a CPU interface 122 (132), in the PD system to which the PD device according to the embodiments can be applied. More specifically, in the PD systems 100 to 400 respectively shown in FIGS. 37 to 40, the controller 16 may be contained in a CPU+interface board 122 (132). In this case, the power line POL and the communication dedicated line COL are used for the CPU+interface board 122, and thereby electric power and communications data can be transmitted. A chip in which the controller 16 is contained in such a CPU+interface board 122 (132) can also be configured as an integrated chip with a CPU including a controller, a DSP, and another controller.

As explained above, according to the embodiments, there can be provided the PD device, the AC adapter, the AC charger, the electronic apparatus, and the PD system, each capable of switching with respect to the plurality of the apparatuses, and each capable of controlling the output voltage value and the available output current capacity (MAX value).

### Other Embodiments

As explained above, the embodiments have been described, as a disclosure including associated description and drawings to be construed as illustrative, not restrictive. This disclosure makes clear a variety of alternative embodiment, working examples, and operational techniques for those skilled in the art.

Such being the case, the embodiments described herein cover a variety of embodiments, whether described or not.

Therefore, the technical scope of the embodiments described herein is determined from the invention specifying items related to the claims reasonable from the above description.

### INDUSTRIAL APPLICABILITY

The PD device, the AC adapter, the AC charger, the electronic apparatus, and the PD system according to the embodiments are applicable to electrical household appliances and electrical equipment, mobile computing devices, etc.

What is claimed is:

1. A power delivery device comprising:
a DC/DC converter disposed between an input and an output;
a primary-side controller configured to control an input current of the DC/DC converter;
a signal conversion circuit coupled to a plurality of control inputs, the signal conversion circuit configured to switch a control input signal of the plurality of the control inputs; and
a secondary-side controller coupled to the signal conversion circuit, the secondary-side controller configured to receive the control input signal switched in the signal conversion circuit, and then feed back the received control input signal to the primary-side controller, wherein
the primary-side controller varies an output voltage value and an available output current capacity of the DC/DC converter by controlling the input current on the basis of the control input signal fed back from the secondary-side controller.

2. The power delivery device according to claim 1, wherein
the signal conversion circuit can be controlled by the secondary-side controller.

3. The power delivery device according to claim 1, wherein
the signal conversion circuit comprises a plurality of switches.

4. The power delivery device according to claim 1, wherein
the secondary-side controller or the signal conversion circuit comprises a voltage and current control circuit configured to execute determination of voltage and current on the basis of the control input signal.

5. The power delivery device according to claim 1, wherein
the control input is directly connected to the signal conversion circuit.

6. The power delivery device according to claim 1, further comprising
a plurality of AC coupling capacitors respectively coupled to the plurality of the control inputs, wherein
the signal conversion circuit is connected to the plurality of the control inputs through the plurality of the AC coupling capacitors.

7. The power delivery device according to claim 1, further comprising
a coupling capacitor configured to couple the secondary-side controller and the signal conversion circuit to each other.

8. The power delivery device according to claim 1, wherein
the signal conversion circuit can execute a conversion selected from the group consisting a frequency conversion, a direct current level conversion, and an amplitude level conversion.

9. The power delivery device according to claim 1, further comprising
an insulation circuit connected to the secondary-side controller, the insulation circuit configured to feed back the control input signal to the primary-side controller.

10. The power delivery device according to claim 9, further comprising
an error amplifier for error compensation connected to the secondary-side controller, the error amplifier configured to feed back the control input signal to the insulation circuit.

11. A power delivery device comprising:
a DC/DC converter disposed between an input and an output;
a primary-side controller configured to control an input current of the DC/DC converter;
a signal conversion circuit coupled to a plurality of control inputs, the signal conversion circuit configured to switch a control input signal of the plurality of the control inputs; and
an insulation circuit coupled to the signal conversion circuit, the insulation circuit configured to receive the control input signal switched in the signal conversion circuit, and then feed back the received control input signal to the primary-side controller, wherein
the primary-side controller varies an output voltage value and an available output current capacity of the DC/DC converter by controlling the input current on the basis of the control input signal fed back from the insulation circuit.

12. The power delivery device according to claim 11, wherein
the control input is directly connected to the signal conversion circuit.

13. The power delivery device according to claim 11, further comprising
a plurality of AC coupling capacitors respectively coupled to the plurality of the control inputs, wherein
the signal conversion circuit is connected to the plurality of the control inputs through the plurality of the AC coupling capacitors.

14. The power delivery device according to claim 11, further comprising
a coupling capacitor configured to couple the insulation circuit and the signal conversion circuit to each other.

15. The power delivery device according to claim 11, wherein
the signal conversion circuit can execute a conversion selected from the group consisting a frequency conversion, a direct current level conversion, and an amplitude level conversion.

16. The power delivery device according to claim 14, wherein
the coupling capacitor is contained in the insulation circuit.

17. An AC adapter comprising the power delivery device according to claim 1.

18. An AC charger comprising the power delivery device according to claim 1.

19. An electronic apparatus comprising the power delivery device according to claim 1.

20. A power delivery system comprising a power delivery device, the power delivery device comprising:
a DC/DC converter disposed between an input and an output;
a primary-side controller configured to control an input current of the DC/DC converter;
a signal conversion circuit coupled to a plurality of control inputs, the signal conversion circuit configured to switch a control input signal of the plurality of the control inputs; and
a secondary-side controller coupled to the signal conversion circuit, the secondary-side controller configured to receive the control input signal switched in the signal conversion circuit, and then feed back the received control input signal to the primary-side controller, wherein
the primary-side controller varies an output voltage value and an available output current capacity of the DC/DC converter by controlling the input current on the basis of the control input signal fed back from the secondary-side controller.
